(19) United States
(12) Patent Application Publication
(10) Pub. No.: US 2025/0274166 A1
(43) Pub. Date: Aug. 28, 2025

(54) WIRELESS COMMUNICATION SYSTEM AND METHOD

(71) Applicant: Huawei Technologies Co., Ltd., Shenzhen (CN)

(72) Inventors: Melissa Duarte Gelvez, Boulogne Billancourt (FR); Mustapha Amara, Boulogne Billancourt (FR); Mohamed Kamoun, Boulogne Billancourt (FR); Sami Mekki, Boulogne Billancourt (FR)

(21) Appl. No.: 19/181,817

(22) Filed: Apr. 17, 2025

Related U.S. Application Data
(63) Continuation of application No. PCT/EP2022/079227, filed on Oct. 20, 2022.

(51) Int. Cl. H04B 7/04; H04L 1/06

(52) U.S. Cl. CPC H04B 7/04013; H04L 1/0668

(57) ABSTRACT

The disclosure provides a wireless communication system, comprising at least one DCS with a surface that comprises scattering elements having a controllable phase shift, at least one transmitter configured to transmit a coded radiofrequency signal to at least one receiver during a plurality of time slots, and a controller. The controller controls the at least one transmitter, based on a space time DCS code (STDC) to generate the coded radiofrequency signal during the plurality of time slots. The controller further controls, based on the STDC, the set of scattering elements of the at least one DCS during the plurality of time slots. The STDC depends on a total number of the at least one DCS and a maximum number of the plurality of time slots Tₘₐₓ.

### CROSS-REFERENCE TO RELATED APPLICATIONS

This application is a continuation of International Application No. PCT/EP2022/079227, filed on Oct. 20, 2022, the disclosure of which is hereby incorporated by reference in its entirety.

### TECHNICAL FIELD

The disclosure relates to wireless communication systems using at least one digitally controllable scatterer (DCS) and a space time DCS code. The disclosure provides a wireless communication system, a corresponding method and a computer program product.

### BACKGROUND

In currently deployed wireless communication systems the wireless channel cannot be controlled hence wireless communication between a transmitter (TX) and a receiver (RX) is achieved via algorithms that adapt the TX and the RX to the given channel conditions. Recent research has proposed a new paradigm for wireless communications where the channel is also controllable by introducing into the propagation environment Large Intelligent Surfaces (LIS), also called Reconfigurable Intelligent Surfaces (RIS) or Reflective Intelligent Surfaces (RIS) in order to use them as Digitally Controllable Scatterers (DCSs). A DCS allows modification of some of the propagation paths of the wireless channel thus enabling the possibility of having a programmable wireless channel, where different algorithms can be used to adapt some of the propagation paths to improve the wireless communication between a TX and an RX. Thus, in this new paradigm, the wireless communication between a TX and an RX is achieved via algorithms that program not only the TX and the RX but also the wireless channel to achieve the required communication.

Most of the algorithms for channel programming using DCS require Channel State Information (CSI) for DCS configuration. However, acquiring this CSI may be time consuming and require large overhead due to the large number of tunable elements that are part of a DCS. In general, a DCS is implemented using a large number, typically hundreds or thousands, of reflective or scattering elements, which are placed on a surface as for example shown in FIG. 1. Non-flat configurations for the DCS surface, as shown for example in FIG. 2a), and distributed configurations, shown exemplary in FIG. 2b), are also valid for DCS implementations. Multiple DCSs can also be implemented by logically splitting a DCS into multiple DCSs through subsets of scattering elements. Each scattering element provides the ability of controlling the phase of its scattered signal. Denoting the scattering phase of a scattering element [symbol] of a DCS d, by [symbol] , the controllable scattering phase configuration matrix ϕ_{d}=[ϕ_{d,1}, ϕ_{d,2}, . . . , ϕ_{d,} [symbol] , . . . , ϕ_{d,} [symbol] _{_{d}}] of the total [symbol] _{d} scattering elements that compose the DCS d provides a way to control the [symbol] _{d}× [symbol] _{d} scattering pattern matrix F_{d} (ϕ_{d}) of the DCS d and thus modify the propagation channel between a TX and an RX. The overall propagation channel h_{m,d,n} between a transmitter antenna TX n and a receiver antenna RX m via the DCS d is a function of the TX to DCS channel, denoted by h_{TX}_{ₙ}_{→DCS}_{_{d}}, the DCS d to RX channel, denoted by h_{DCS}_{_{d}}_{→RX}_{ₘ} and the scattering pattern F_{d} (ϕ_{d}), and is given by Equation (1):

$${h}_{m , d , n} = {h}_{{DCS}_{d} \to {RX}_{m}}^{T} {F}_{d} ( {ϕ}_{d} ) {h}_{{TX}_{n} \to {DCS}_{d}} \qquad ( 1 )$$

where the superscript (.)^{T} denotes transpose. FIG. 3 shows an exemplary channel h_{TX}_{ₙ}_{→DCS}_{_{d}} from a TX n to a DCS d, an exemplary channel h_{DCS}_{_{d}}_{→RX}_{ₘ} from the DCS d to RX m, and an exemplary channel h_{m,d,n} between a transmitter antenna TX n and a receiver antenna RX m via the DCS d.

Configuring the DCS scattering phases ϕ_{d} based on the knowledge of the channel components h_{TX}_{ₙ}_{→DCS}_{_{d}} h_{DCS}_{_{d}}_{→RX}_{ₘ} or a function of them has the following problems:
Large matrices need to be computed. The channel matrices h_{TX}_{ₙ}_{→DCS}_{_{d}} and h_{DCS}_{_{d}}_{→RX}_{ₘ} are both of size S_{d}×1, therefore these matrices can be quite large since their sizes depend on the number of scattering elements S_{d} of the DCS, that usually is quite large, as mentioned above. The large size of the channel matrices complicates the channel estimation. For simplification, only the cascaded channel

$${h}_{{DCS}_{d} \to {RX}_{m}}^{T} diag ( {h}_{{TX}_{n} \to {DCS}_{d}} )$$

is customarily estimated; however, this cascaded channel has S_{d} elements and, hence, is also a large channel matrix. Simplifications, where only the statistics of h_{TX}_{ₙ}_{→DCS}_{_{d}} and h_{DCS}_{_{d}}_{→RX}_{ₘ} are estimated, have been proposed to allow channel estimation at a slower time scale. Nonetheless, the computed statistical CSI matrices still have a size that remains a function of S_{d}.
Feedback is required. DCSs are envisioned to be devices with low capabilities; therefore they shall include none or only a limited number of RF chains. As a result, channel estimation cannot be performed at the DCS and is typically performed at the RX. When the DCS phases ϕ_{d} are designed as a function of the measured channels h_{TX}_{ₙ}_{→DCS}_{_{d}} and h_{DCS}_{_{d}}_{→RX}_{ₘ}, then configuring the DCS phases requires feeding back to the DCS said channels or the required configuration ϕ_{d}. If the CSI in the form of channels h_{TX}_{ₙ}_{→DCS}_{_{d}} and h_{DCS}_{_{d}}_{→RX}_{ₘ} is exchanged, this results in a large feedback overhead due to the size of the channel matrices. If only ϕ_{d} is fed back, the overhead is still large since the size of ϕ_{d} also depends on the number of scattering elements S_{d}. Some reduction on feedback overhead has been proposed via successive refinement algorithms, but these have the problem of requiring multiple rounds of pilots, channel estimation, and feedback. Even if the amount of feedback can be reduced via the use of codebooks, the delay in feeding back information can be detrimental to the system performance in scenarios with low channel coherence times.

Although the benefits of DCS for communication improvement, for example coverage improvement, have been demonstrated, most of the proposed algorithms have the two problems raised above, namely complexity of CSI acquisition and feedback.

A solution for large CSI requirement and feedback overhead has been proposed and uses a random configuration of the DCS phases ϕ_{d}. With a random design of ϕ_{d}, there is no need for CSI at the DCS for phase configuration. Furthermore, the random phases ϕ_{d} can be generated at the DCS; hence, the overhead of communicating ϕ_{d} to the DCS is also not needed. The random phases at the DCS create random channel propagation paths, which are opportunistically used in a way similar to opportunistic beamforming. The channel variations that are created can be limited when only one DCS is used and, thus, several DCSs may be needed in order to generate large enough channel variations in order to achieve a desired multiuser diversity via DCS random channels. Furthermore, although CSI is not needed for DCS phase configuration, feedback delay is introduced, since the channel link quality must be fed back from the users to the TX.

Random phases ϕ_{d} for DCS configuration without the need for CSI at the DCS and without the need for communicating ϕ_{d} has been proposed. Nevertheless, setting phases randomly without coordination between DCS elements may result in low energy at the receiver.

Space Time Block Code (STBC) algorithms have been proposed to overcome the requirement of CSI estimation before data transmission. A STBC is a code that is applied at the transmitter and that does not require CSI at the transmitter. A STBC is represented by a matrix, which maps n complex symbols {s₁, s₂, . . . , s_{η}} onto a τ×μ matrix, i.e. a matrix of τ rows and μ columns. Most of the known STBC matrices have been designed for coding η symbols across μ transmit antennas and τ time slots, where τ≥μ and η≤μ. A STBC example is the Alamouti code that corresponds to the case of η=2, τ=2, μ=2 and is given in Equation (2):

$$[ \begin{matrix}{s}_{1} & {s}_{2} \\ - {s}_{2}^{*} & {s}_{1}^{*}\end{matrix} ] \qquad ( 2 )$$

A DCS illuminated with a dedicated transmitter antenna using the Alamouti code, where the transmitter antenna transmits a single tone carrier, has been proposed. The information symbols {s₁, s₂} to be transmitted are communicated to the DCS (via a wire or a dedicated connection) and then used to configure the DCS phases ϕ_{d}, such that the signal scattered by the DCS is the carrier tone with an Alamouti encoding of symbols {s₁, s₂}. Although CSI is not needed at the DCS, the DCS needs to know the information symbols to be transmitted, which still adds overhead for control of the DCS. Moreover, only the propagation path via the DCS is used so that if other non-DCS propagation paths (i.e., direct paths) exist, they are not accounted for. Furthermore, since the DCS scattering elements mainly provide with phase control, then mainly symbols from constellations with constant amplitude can be transmitted. DCS elements that provide both amplitude and phase control may be more expensive to implement.

### SUMMARY

In view of the above, this disclosure aims to overcome the problems of large CSI requirements and feedback overhead for DCS algorithms. An objective is to provide a wireless communication system and method that use an algorithm that reduces CSI knowledge and feedback requirements for communication enhancement using one or more DCS.

This and other objectives are achieved by this disclosure according to the solutions described in the independent claims. Advantageous implementations are further described in the dependent claims.

A first aspect of this disclosure provides a wireless communication system comprising: at least one transmitter, configured to transmit a coded radiofrequency signal to at least one receiver during a plurality of time slots; at least one digitally controllable scatterer, DCS, the DCS comprising a scattering surface that comprises a set of scattering elements, each scattering element having a controllable phase shift; a controller; and at least one receiver, configured to obtain by reception, during the plurality of time slots, the coded radiofrequency signal transmitted by the at least one transmitter. The controller is configured to: control, based on a space time DCS code (STDC) the at least one transmitter to generate the coded radiofrequency signal during the plurality of time slots; and control, based on the STDC, the set of scattering elements of the at least one DCS during the plurality of time slots, where the coded radiofrequency signal transmitted by the at least one transmitter during the plurality of time slots propagates from the at least one transmitter to the at least one receiver through one or more propagation channels, the one or more propagation channels comprising one or more propagation channels via the at least one DCS and/or one or more direct propagation channels, and where the STDC depends on a total number of the at least one DCS and a maximum number of the plurality of time slots Tₘₐₓ.

The STDC thus defines a configuration of the at least one transmitter and of the at least one DCS during the plurality of time slots.

This provides the advantage of enabling a STDC for DCS configuration, transmitter coded signal generation and receiver processing that does not require CSI feedback nor estimation of large channel matrices.

Further advantageously, overhead in transmitting the STDC may also be reduced and efficiency can be enhanced.

In an implementation form of the first aspect, the STDC comprises a STDC matrix B, the STDC matrix B having a dimension T×D, wherein D is a total number of the at least one DCS, with D≥1, and T≤Tₘₐₓ is a total number of the plurality of time slots.

In an implementation form of the first aspect, the total number of the plurality of time slots satisfies Tₘₐₓ≥D, wherein the STDC matrix B is defined based on δ≤D complex values {β₁, β₂, . . . , β_{δ}}, and wherein entries of a row i of the matrix B belong either to {±β₁, ±β₂, . . . , ±β_{δ}, 0} or to {±β*₁, ±β*₂, . . . , ±β*_{δ}, 0}, wherein [symbol] is the complex conjugate of [symbol] for ∀ [symbol] ∈{1, . . . , D}.

Notably, the STDC does not depend on the number of scattering elements of the at least one DCS. Thus, efficiency may be enhanced and low overhead may be obtained.

In an implementation form of the first aspect, a code for each of the at least one DCS d, with d∈{1,2, . . . , D}, is determined by a respective d-th column of the STDC matrix B, the d-th column of the STDC matrix B being denoted as B_{d}.

This provides the advantage that the code for the at least one DCS can be easily determined by choosing the respective column of the STDC matrix B.

In an implementation form of the first aspect, for a time slot tᵢ∈{t₁, t₂, . . . , t_{T}}, the controller is configured to determine a coded configuration for each of the at least one DCS d, with d∈{1,2, . . . , D}, as B_{i,d} F_{d} (ϕ_{d}), wherein F_{d} (ϕ_{d}) is a scattering pattern of the at least one DCS d, ϕ_{d} is a base phase shift configuration matrix of the at least one DCS d, and B_{i,d} denotes an entry in an i-th row of the respective code B_{d}.

This provides the advantage that the coded configuration for the at least one DCS may be a phase shifted version of the scattering pattern F_{d} (ϕ_{d}), where the phase shift is given by α_{d}=B_{i,d}. Consequently, the coverage of the at least one DCS when using the phase shifted scattering pattern α_{d} F_{d} (ϕ_{d}) may be the same as when using F_{d} (ϕ_{d}) since the phase shift α_{d} does not change the scattering pattern in terms of energy perceived at each point in space. This is beneficial since the one or more propagation channels via the at least DCS may remain fixed even when the coding is applied, and the major change is their overall phases. As a result, by using the STDC according to this disclosure, at least one propagation path via the at least one DCS can be created and it may remain fixed during the plurality of time slots. This facilitates channel estimation and signal combining at the at least one receiver.

Further, the programming of the DCS according to this disclosure has the advantage that the information symbols are only required at the at least one transmitter, but not at the at least one DCS. This is an important difference with respect to the state of the art that implements the STBC Alamouti with DCS, whereby the information symbols are required at the DCS for DCS programming resulting in large overhead for communication of the information symbols to the at least one DCS.

In an implementation form of the first aspect, for each time slot tᵢ, with tᵢ∈{t₁, t₂, . . . , t_{T}}, the at least one transmitter is further configured to transmit an information symbol x in the coded radiofrequency signal, where the coded radiofrequency signal comprises a transformation of the information symbol x based on the STDC matrix B, and the transformation of the information symbol x comprises: the information symbol x at the time slot tᵢ if entries of a respective i-th row of the STDC matrix B belong to {±β₁, ±β₂, . . . , ±β_{δ}, 0}, or an information symbol x* at the time slot tᵢ if entries of the respective i-th row of the STDC matrix B belong to {±β*₁, ±β*₂, . . . , ±β*_{δ}, 0}, wherein x+is the complex conjugate of the information symbol x.

The proposed STDC can be applied to multiple independent single antenna transmitters, and can also apply for coding with only a single antenna transmitter. This is a desirable feature in communication systems with low complexity devices, for example, in internet of things (IoT) devices that may not be able to implement STBC, which require coding over at least two transmitter antennas.

Further advantageously, this may enable that the symbols sent by the at least one transmitter can be taken from constellations with varying amplitude.

In an implementation form of the first aspect, the at least one receiver is configured to estimate the one or more propagation channels via the at least one DCS, additionally or alternatively the one or more direct propagation channels.

In an implementation form of the first aspect, for each time slot tᵢ, with tᵢ∈{t₁, t₂, . . . , t_{T}}, the at least one receiver is further configured to determine the information symbol x transmitted by the at least one transmitter based on the STDC, based on the received coded radiofrequency signal, and based on the estimated one or more propagation channels via the at least one DCS, additionally or alternatively the estimated one or more direct propagation channels.

The estimation of the information symbol x by the at least one receiver may be based, for example, on diversity combining.

This provides the advantage that channel estimates may only be performed and required at the receiver; hence, feedback may not be needed. Furthermore, the number of entries of the estimated channel matrices does not depend on the number of DCS scattering elements S_{d} and it is much smaller than S_{d}.

In an implementation form of the first aspect, one of: the controller, the at least one transmitter, the at least one receiver or the at least one DCS is further configured to determine the STDC matrix B, and send the total number T of the plurality of time slots and the STDC matrix B by signaling to the controller and/or the at least one transmitter and/or the at least one receiver and/or the at least one DCS, or send by signaling to the at least one DCS d the respective d-th column of the STDC matrix B and the total number T of the plurality of time slots.

Since the STDC matrix B only has T×D elements, the overhead on signaling the STDC matrix B may be small.

Further, by sending to the at least one DCS the respective d-th column of the STDC matrix B, instead of the full STDC matrix B, a further overhead reduction may be achieved.

In an implementation form of the first aspect, the STDC matrix B is determined offline, and the STDC matrix B, additionally or alternatively the d-th column of the STDC matrix B, is sent by signaling before the at least one transmitter transmits the coded radiofrequency signal.

This provides the advantage that overhead may be further reduced and efficiency may be enhanced.

In an implementation form of the first aspect, the at least one transmitter and the at least one DCS are synchronized.

A second aspect of this disclosure provides a wireless communications method comprising: controlling, by a controller, based on a space time DCS code, STDC, at least one transmitter to generate a coded radiofrequency signal during a plurality of time slots; controlling, by the controller, based on the STDC, a set of scattering elements of at least one DCS during the plurality of time slots, the at least one DCS comprising a scattering surface that comprises the set of scattering elements, each scattering element having a controllable phase shift; transmitting, by the at least one transmitter, the coded radiofrequency signal to at least one receiver during the plurality of time slots; and obtaining by reception, by the at least one receiver, during the plurality of time slots, the coded radiofrequency signal transmitted by the at least one transmitter; where the coded radiofrequency signal transmitted by the at least one transmitter during the plurality of time slots propagates from the at least one transmitter to the at least one receiver through one or more propagation channels, the one or more propagation channels comprising one or more propagation channels via the at least one DCS and/or one or more direct propagation channels; and where the STDC depends on a total number of the at least one DCS and a maximum number of the plurality of time slots Tₘₐₓ.

The STDC thus defines a configuration of the at least one transmitter and of the at least one DCS during the plurality of time slots.

This provides the advantage of enabling a STDC for DCS configuration, transmitter coded signal generation and receiver processing that does not require CSI feedback nor estimation of large channel matrices.

Further advantageously, overhead in transmitting the STDC may also be reduced, and efficiency can be enhanced.

In an implementation form of the second aspect, the STDC comprises a STDC matrix B, the STDC matrix B having a dimension T×D, wherein D is a total number of the at least one DCS, with D≥1, and T≤Tₘₐₓ is a total number of the plurality of time slots.

In an implementation form of the second aspect, the total number of the plurality of time slots satisfies Tₘₐₓ≥D, wherein the STDC matrix B is defined based on δ≤D complex values {β₁, β₂, . . . , β_{δ}}, and wherein entries of a row i of the matrix B belong either to {±β₁, ±β₂, . . . , ±β_{δ}, 0} or to {±β*₁, ±β*₂, . . . , ±β*_{δ}, 0}, wherein [symbol] is the complex conjugate of [symbol] for ∀ [symbol] ∈{1, . . . , D}.

Notably, the STDC does not depend on the number of scattering elements of the at least one DCS. Thus, efficiency may be enhanced and low overhead may be obtained.

In an implementation form of the second aspect, a code for each of the at least one DCS d, with d∈{1,2, . . . , D}, is determined by a respective d-th column of the STDC matrix B, the d-th column of the STDC matrix B being denoted as B_{d}.

This provides the advantage that the code for the at least DCS can be easily determined by choosing the respective column of the STDC matrix B.

In an implementation form of the second aspect, the controlling, by the controller, based on the STDC, a set of scattering elements of the at least one DCS during the plurality of time slots, comprises determining by the controller, for a time slot tᵢ∈{t₁, t₂, . . . , t_{T}}, a coded configuration for each of the at least one DCS d, with d∈{1,2, . . . , D}, as B_{i,d} F_{d} (ϕ_{d}), wherein F_{d} (ϕ_{d}) is a scattering pattern of the at least one DCS d, ϕ_{d} is a base phase shift configuration matrix of the at least one DCS d, and B_{i,d} denotes an entry in an i-th row of the respective code B_{d}.

This provides the advantage that the coded configuration for the at least one DCS may be a phase shifted version of the scattering pattern F_{d} (ϕ_{d}), where the phase shift is given by α_{d}=B_{i,d}. Consequently, the coverage of the at least one DCS when using the phase shifted scattering pattern α_{d} F_{d} (ϕ_{d}) may be the same as when using F_{d} (ϕ_{d}) since the phase shift α_{d} does not change the scattering pattern in terms of energy perceived at each point in space. This is beneficial since the one or more propagation channels via the at least one DCS may remain fixed even when the coding is applied, and the major change is their overall phases. As a result, by using the STDC according to this disclosure, at least one propagation path via the at least one DCS can be created and it may remain fixed during the plurality of time slots. This facilitates channel estimation and signal combining at the at least one receiver.

Further, the programming of the DCS according to this disclosure has the advantage that the information symbols are only required at the at least one transmitter, but not at the at least one DCS. This is an important difference with respect to the state of the art that implements the STBC Alamouti with DCS, whereby the information symbols are required at the DCS for DCS programming resulting in large overhead for communication of the information symbols to the at least one DCS.

In an implementation form of the second aspect, the controlling, by the controller, based on the STDC, the at least one transmitter to generate a coded radiofrequency signal during a plurality of time slots, comprises transmitting, by the at least one transmitter, for each time slot tᵢ, with tᵢ∈{t₁, t₂, . . . , t_{T}}, an information symbol x in the coded radiofrequency signal, where the coded radiofrequency signal comprises a transformation of the information symbol x based on the STDC matrix B, and the transformation of the information symbol x comprises: the information symbol x at the time slot tᵢ if entries of a respective i-th row of the STDC matrix B belong to {±β₁, ±₂, . . . , ±β_{δ}, 0}, or an information symbol x* at the time slot tᵢ if entries of the respective i-th row of the STDC matrix B belong to {±β*₁, ±β*₂, . . . , ±β*_{δ}, 0}, wherein x* is the complex conjugate of the information symbol x.

The proposed STDC can be applied to multiple independent single antenna transmitters, and can also apply for coding with only a single antenna transmitter. This is a desirable feature in communication systems with low complexity devices, for example in IoT devices that may not be able to implement STBC, which require coding over at least two transmitter antennas.

Further advantageously, this may enable that the symbols sent by the at least one transmitter can be taken from constellations with varying amplitude.

In an implementation form of the second aspect, the method further comprises estimating, by the at least one receiver, the one or more propagation channels via the at least one DCS, additionally or alternatively the one or more direct propagation channels.

In an implementation form of the second aspect, the method further comprises, for each time slot tᵢ, with tᵢ∈{t₁, t₂, . . . , t_{T}}, determining, by the at least one receiver, the information symbol x transmitted by the at least one transmitter based on the STDC, based on the received coded radiofrequency signal, and based on the estimated one or more propagation channels via the at least one DCS, additionally or alternatively the estimated one or more direct propagation channels.

The estimation of the information symbol x by the at least one receiver may be based, for example, on diversity combining.

This provides the advantage that channel estimates may only be performed and required at the receiver; hence, feedback may not be needed. Furthermore, the number of entries of the estimated channel matrices does not depend on the number of DCS scattering elements S_{d} and it is much smaller than S_{d}.

In an implementation form of the second aspect, the method further comprises determining, by one of: the controller, the at least one transmitter, the at least one receiver or the at least one DCS, the STDC matrix B. Additionally, the method comprises sending, by the at least one transmitter, the at least one receiver or the at least one DCS, the total number T of the plurality of time slots and the STDC matrix B by signaling to the controller and/or the at least one transmitter and/or the at least one receiver and/or the at least one DCS, or sending by signaling to the at least one DCS d the respective d-th column of the STDC matrix B and the total number T of the plurality of time slots.

Since the STDC matrix B only has T×D elements, the overhead on signaling the STDC matrix B may be small.

Further, by sending to the at least one DCS the respective d-th column of the STDC matrix B, instead of the full STDC matrix B, a further overhead reduction may be achieved.

In an implementation form of the second aspect, the method further comprises determining STDC matrix B offline, and sending by signaling the STDC matrix B, additionally or alternatively the d-th column of the STDC matrix B, before the at least one transmitter transmits the coded radiofrequency signal.

This provides the advantage that overhead may be further reduced and efficiency may be enhanced.

In an implementation form of the second aspect, the method further comprises that the at least one transmitter and the at least one DCS are synchronized.

The method according to the second aspect comprises the features of the corresponding implementation forms of the wireless communication system of the first aspect.

A third aspect of this disclosure provides a computer program product comprising a program code for carrying out, when implemented on a processor, the method according to the second aspect or its implementation forms.

The computer program product according to the third aspect comprises the features of the corresponding implementation forms of the method of the second aspect.

The method according to the second aspect and the computer program product according to the third aspect and their implementation forms provide the same advantages and effects as described above for the wireless communication system of the first aspect and its respective implementation forms.

The solutions according to present disclosure may provide the following advantages:
Enable diversity combining of different channel propagation paths even for scenarios with only a single antenna at the transmitter and the receiver.
The coding applied at the at least one DCS is independent of the transmitted information symbols.
More flexibility on the types of channels generated with DCS can be achieved.
Feedback is not needed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms will be explained in the following description of specific embodiments in relation to the enclosed drawings, in which

FIG. 1 shows an example of a DCS;

FIG. 2a)-b) show exemplary configurations of non-flat DCS scattering surfaces, and an exemplary configuration of a distributed DCS scattering surface;

FIG. 3 shows an exemplary signal that propagates from a transmitter to a receiver via a DCS through a propagation channel that depends on the channel from the transmitter to the DCS, the channel from the DCS to the receiver, and the scattering pattern of the DCS;

FIG. 4 shows a schematic diagram of a wireless communication system according to this disclosure;

FIG. 5 shows an exemplary flowchart for generating a space time DCS code according to this disclosure;

FIG. 6 shows a schematic diagram of an example of a wireless communication system according to this disclosure;

FIG. 7 shows a schematic diagram of an example of a wireless communication system according to this disclosure

FIG. 8a)-b) show schematic diagrams of examples of a wireless communication system according to this disclosure.

FIG. 9 shows a schematic diagram of an example of a wireless communication system according to this disclosure;

FIG. 10 shows an example of exchanged information between the controller, one transmitter, two DCS and one receiver according to this disclosure;

FIG. 11 shows another example of exchanged information between the controller, one transmitter, two DCS and one receiver according to this disclosure;

FIG. 12 shows an example of exchanged information between the controller, one transmitter, D DCS and one receiver according to this disclosure;

FIGS. 13a)-b) show of examples of time slots in a wireless communication system according to this disclosure for the case of four information symbols transmitted.

FIG. 14 shows a wireless communications method according to this disclosure.

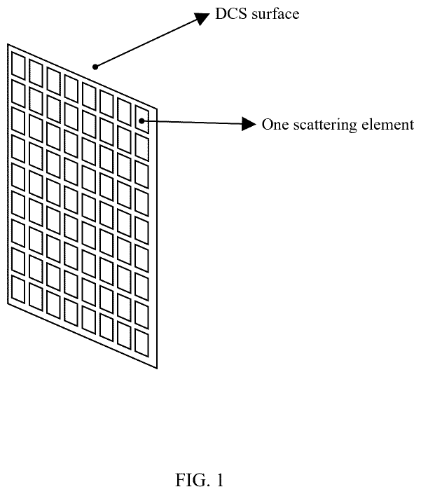

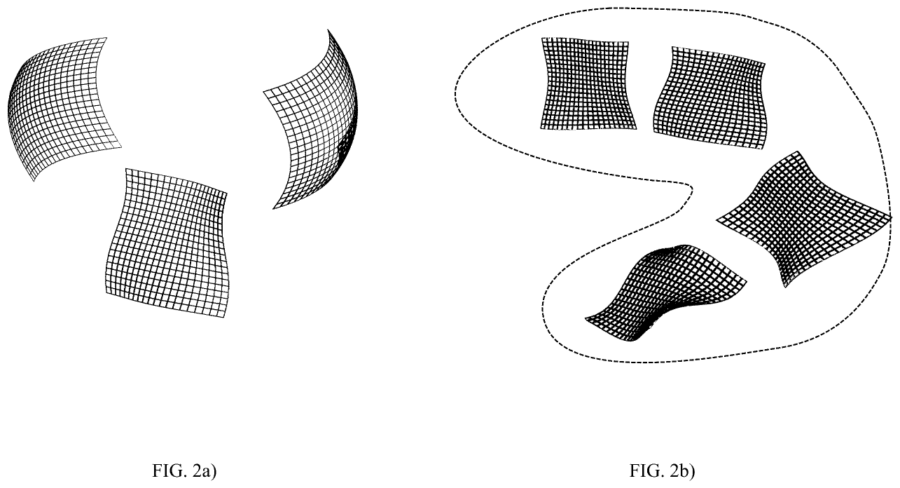

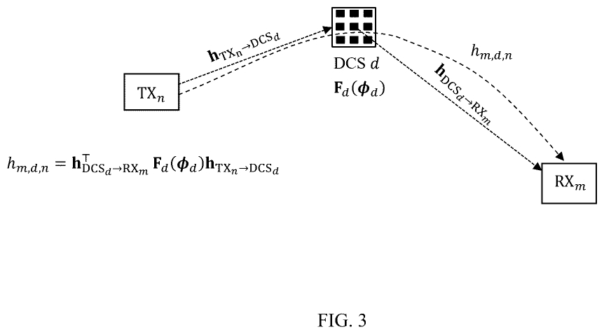

### DETAILED DESCRIPTION OF ILLUSTRATIVE EMBODIMENTS

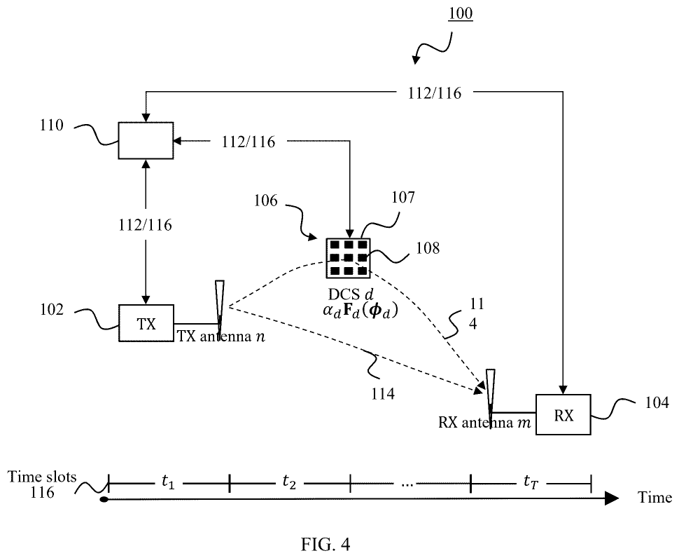

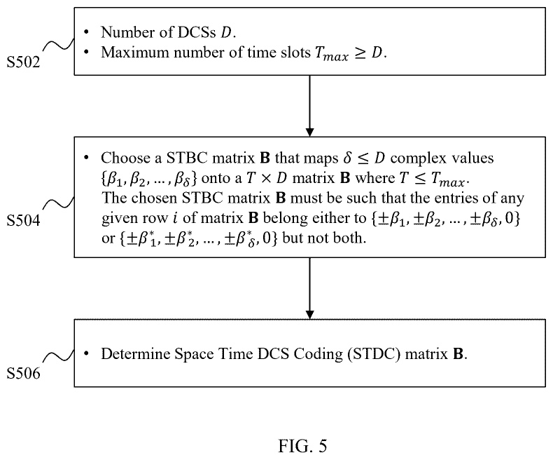

FIG. 4 shows an exemplary embodiment of a wireless communication system 100 according to this disclosure. The wireless communication system 100 comprises at least one transmitter 102, configured to transmit a coded radiofrequency signal to at least one receiver 104 during a plurality of time slots 116. The system 100 further comprises at least one DCS 106 with a scattering surface 107. The scattering surface 107 comprises a plurality of scattering elements 106, each scattering element 106 has a controllable phase shift. The system 100 further comprises a controller 110, and at least one receiver 104 configured to obtain by reception, during the plurality of time slots 116, the coded radiofrequency signal transmitted by the at least one transmitter 102.

The controller 110 is configured to control, based on a space time DCS code 112, STDC, the at least one transmitter 102 to generate the coded radiofrequency signal during the plurality of time slots 116.

Further, the controller 110 is configured to control, based on the STDC 112, the set of scattering elements 108 of the at least one DCS 106 during the plurality of time slots 116. Thereby, the scattering elements 108 of the scattering surface 107 of the DCS 106 scatter the coded signal transmitted by the at least one transmitter 102 in a controlled manner that is based on the code STDC 112. Notably, since the STDC 112 does not depend on the number of scattering elements 108 of each of the at least one DCS, efficiency and low overhead is obtained.

The STDC 112 depends on a total number of the at least one DCS 106 and a maximum number of the plurality of time slots 116, denoted as Tₘₐₓ.

The coded radiofrequency signal transmitted by the at least one transmitter 102 during the plurality of time slots 116 propagates from the at least one transmitter 102 to the at least one receiver 104 through one or more propagation channels 114. The one or more propagation channels 114 comprise one or more propagation channels via the at least one DCS 106. Additionally or alternatively, the one or more propagation channels 114 comprise one or more direct propagation channels. That is, the one or more propagation channels 114 comprise one or more propagation channels between the at least one transmitter 102 and the at least one receiver 104 via the at least one DCS 106. Additionally or alternatively, the one or more propagation channels 114 comprise one or more direct propagation channels between the at least one transmitter 102 and the at least one receiver. The one or more propagation channels 114 may not comprise direct propagation channels between the at least one transmitter 102 and the at least one receiver, for example in case that the direct propagation channels between the at least one transmitter 102 and the at least one receiver are blocked.

The STDC 112 comprises a STDC matrix B. The STDC matrix B has a dimension T×D, where D is a total number of the at least one DCS 106, so that D≥1, and T≤Tₘₐₓ is a total number of the plurality of time slots 116, and the maximum number of the plurality of time slots 116 is smaller than or equal to the total number of DCSs 106, Tₘₐₓ≥D.

The STDC matrix B is defined based on δ complex values {β₁, β₂, . . . , β_{δ}}, and a number of said complex values is smaller or equal than the total number of DCSs 106, i.e., δ≤D. Entries of a row i of the STDC matrix B belong either to {±β₁, ±β₂, . . . , ±β_{δ}, 0} or to {±β*₁, ±β*₂, . . . , ±β*_{δ}, 0}, where [symbol] is the complex conjugate of [symbol] for ∀ [symbol] ∈{1, . . . , D}.

The STDC matrix B can be derived from conventional STBC matrices. An exemplary flowchart for generating the STDC matrix B according to this disclosure is depicted in FIG. 5.

In step S502, the flowchart may take as inputs the total number of DCSs D and the maximum number of time slots 106 Tₘₐₓ≥D that are available or allowed for STDC.

Then, in step S504, a STBC matrix B that maps δ≤D complex values {β₁, β₂, . . . , β_{δ}} onto a T×D matrix B may be chosen, such that T≤Tₘₐₓ. The matrix B may be chosen such that the entries of any row i of B belong either to {±β₁, ±β₂, . . . , ±β_{δ}, 0} or to {±β*₁, ±β*₂, . . . , ±β*_{δ}, 0} but not both, where [symbol] is the complex conjugate of [symbol] for ∀ [symbol] ∈{1, . . . , D}. This constraint is related to the fact that the effect of a common scattering phase shift for all the scattering elements 108 of the DCS 106 affects the entire signal scattered by it with an overall phase shift, as explained later in the disclosure.

In step S506, the STDC matrix B may be determined by assigning to it the matrix chosen in step S504. The exemplary flowchart of FIG. 5 may provide the STDC matrix B as an output.

Referring to FIG. 4, a code for each of the at least one DCS d 106, with d∈{1,2, . . . , D}, is determined by a respective d-th column of the STDC matrix B. The d-th column of the STDC matrix B, which is denoted as B_{d}, can also be referred to as a coding vector for the DCS d 106.

That is, for a total number of D DCSs 106, the code of the d-th DCS 106 (hereinafter in this disclosure it may be referred to as DCS d), with d∈{1,2, . . . , D}, is specified by the d-th column of the STDC matrix B. Thereby, a given DCS d 106 only requires knowledge of the corresponding column d of B.

Then, for each of the plurality of time slots 116, tᵢ∈{t₁, t₂, . . . , t_{T}}, the controller 110 is configured to determine a coded configuration for each of the at least one DCS 106 d, with d∈{1,2, . . . , D}, as B_{i,d} F_{d} (ϕ_{d}), where F_{d} (ϕ_{d}) is a scattering pattern of the at least one DCS d 106, ϕ_{d} is a base phase shift configuration matrix of the at least one DCS d 106, and B_{i,d} denotes an entry in an i-th row of the respective code B_{d}, i.e., B_{i,d} is the entry in in the i-th row and the d-th column of the STDC matrix B.

On controlling, based on the STDC 112, the set of scattering elements 108 of the at least one DCS 106 during the plurality of time slots 116, the controller 110 may control the at least one DCS 106 d to chose the d-th column of the STDC matrix B and to further determine the coded configuration mentioned above. Additionally or alternatively, the controller 110 may control the at least one DCS 106 during the plurality of time slots 116 in order to apply the determined coded configuration.

The base phase shift configuration matrix of the at least one DCS d 106 ϕ_{d} can be determined locally at the corresponding DCS d 106. As such, each DCS d 106 can determine ϕ_{d} independently and in a non-coordinated manner without signaling requirements. Alternatively, the controller may be configured to determine ϕ_{d} for each of the DCS d 106 and may send each ϕ_{d} to each DCS d 106 by signaling.

The coded configuration for each of the at least one DCS 106 d during a time slot tᵢ takes the form B_{i,d} F_{d} (ϕ_{d})=α_{d} F_{d} (ϕ_{d}), i.e., the coded configuration for each of the at least one DCS 106 d is a scaled version of the scattering pattern F_{d} (ϕ_{d}), where the scaling is given by α_{d}. When the entries of the STDC matrix B are all of unit magnitude then the coverage of the at least one DCS d 106 when using a_{d} F_{d} (ϕ_{d}) is the same as when using F_{d} (ϕ_{d}) since the complex scalar a_{d} scaling the scattering pattern F_{d} (ϕ_{d}) is of unit magnitude thus scaling by α_{d} corresponds to applying a phase shift to the scattering pattern F_{d} (ϕ_{d}). Rotating the scattering pattern F_{d} (ϕ_{d}) by a phase shift does not change the scattering pattern in terms of energy perceived at each point in space, that is, the magnitude of the scattering pattern of the at least one DCSs 106 is not changed. This is beneficial since the one or more propagation channels via the at least DCS 106 remain fixed even when the coding is applied, and the only change is their overall phases (shifted by <(α_{d})). As a result, by using the STDC 112 according to this disclosure, at least one propagation path via the at least one DCS 106 remains fixed up to a phase shift during the plurality of time slots 116, which facilitates channel estimation and signal combining at the at least one receiver 104.

The base phase shift configuration matrix ϕ_{d} for each of the at least one DCS 106 and hence F_{d} (ϕ_{d}), may be determined in a flexible manner since the coding can be applied on top of the scattering pattern as an overall scaling defined by α_{d}. In other words, the coding according to this disclosure applies on top of any given scattering pattern F_{d} (ϕ_{d}); hence, the STDC 112 provides more flexibility than conventional coding, where the code imposes a phase shift pattern ϕ_{d} that is updated throughout the coding hence a varying scattering pattern F_{d} (ϕ_{d}) is imposed and, as a result, the scattering pattern varies throughout the coding time slots.

Using Equation (1), a propagation channel via the DCS d 106 from a transmitter antenna of the at least one transmitter 102, referred to as transmitter antenna n, to a receiver antenna of the at least one receiver 104, referred to as receiver antenna m, when using the scattering pattern α_{d} F_{d} (ϕ_{d}) can be written as shown in Equation (3):

$$\begin{matrix}{g}_{m , d , n} = {h}_{{DCS}_{d} \to {RX}_{m}}^{T} ( {α}_{d} {F}_{d} ( {ϕ}_{d} ) ) {h}_{{TX}_{n} \to {DCS}_{d}} \\ = {α}_{d} ( {h}_{{DCS}_{d} \to {RX}_{m}}^{T} {F}_{d} ( {ϕ}_{d} ) {h}_{{TX}_{n} \to {DCS}_{d}} ) \\ = {α}_{d} {h}_{m , d , n}\end{matrix} \qquad ( 3 )$$

Since the STDC 112 according to this disclosure may change only α_{d}, it can be noted from Equation (3) that the coding results in a scaling of the underlying or base channel h_{m,d,n}, which itself remains fixed during the T time slots 116. FIG. 4 shows a propagation channel 114 from the at least one transmitter 102 to the at least one receiver 104 via the at least one DCS 106, given by g_{m,d,n} in Equation (3), when the at least one DCS d 106 uses the scattering pattern α_{d} F_{d} (ϕ_{d}).

In the exemplary embodiment of FIG. 4, for each time slot 116 tᵢ, with tᵢ∈{t₁, t₂, . . . , t_{T}}, the transmitter antenna n of the at least one transmitter 102 is further configured to transmit an information symbol x in the coded radiofrequency signal, where the coded radiofrequency signal comprises a transformation of the information symbol x based on the STDC matrix B.

The transformation of the information symbol x may be denoted generally as f_{TX} (x, B, tᵢ) and comprises: the information symbol x at the time slot 116 tᵢ if entries of a respective i-th row of the STDC matrix B belong to {±β₁, ±β₂, . . . , ±β_{δ}, 0}, or an information symbol x* at the time slot 116 tᵢ if entries of the respective i-th row of the STDC matrix B belong to {±β*₁, ±β*₂, . . . , ±β*_{δ}, 0}, where x* is the complex conjugate of the information symbol x.

The information symbol x to be transmitted by the transmitter antenna n of the at least one transmitter 102 only needs to be known at the at least one transmitter 102 and does not need to be known by the at least one DCS 106, thus, the wireless communication system 100 may reduce the overhead requirement. This is in contrast to the prior art, where the information symbol needs to be known at the at least one DCS 106.

Each of the at least one transmitter 102 may comprise a single transmitter antenna. Alternatively, each of the at least one transmitter 102 may comprise multiple transmitter antennas, and each transmitter antenna may be configured to transmit, based on the STDC 112, a different information symbol during the T time slots. In other words, in case that the at least one transmitter 102 may comprise multiple transmitter antennas, transmission from each transmitter antenna may be performed independently at each transmitter antenna and, hence, each transmitter antenna may be configured to transmit an independent information symbol x by coding its corresponding information symbol x using the STDC 112, as disclosed above, over the T time slots 116.

In this manner, the STDC 112 according to this disclosure can be a code for multiple independent single antenna transmitters, or for multiple independent multi antenna transmitters, and can also apply for coding with only a single transmitter with multiple antennas or for coding with only a single transmitter with only a single antenna. The latter is a desirable feature in communication systems with low complexity devices, for example IoT devices that may not be able to implement STBC as it would require coding over at least two transmitter antennas. In other words, the STDC 112 may allow taking advantage of space time diversity by coding one or more propagation channels via one or more DCSs instead of coding a symbol over multiple transmitter antennas.

Further advantageously, in the exemplary embodiment of the wireless communication system 100 of FIG. 4, the transmitted symbol x can be taken from any variable amplitude constellation, for example QAM with any number of constellation points (e.g. 4-QAM, 8-QAM, 16-QAM), or can be taken from PSK constellations, even if the DCS elements provide only phase shift control. In contrast, in customary Alamouti designs with DCS the symbols must be constant amplitude, hence limited to PSK constellations (e.g. 4-PSK, 8-PSK, 16-PSK) that have a worse performance than QAM constellations, when the DCS elements only provide phase shift control.

Referring to FIG. 4, the at least one transmitter 102 and the at least one DCS 106 are synchronized. Synchronization between the at least one transmitter 102 and the at least one DCS 106 can be achieved, for example, by using GPS signals. GPS-based synchronization is used in 5G to in order to synchronize evolved Node B (eNBs).

In the exemplary embodiment of FIG. 4, the at least one receiver 104 is configured to estimate the one or more propagation channels between the at least one transmitter and the at least one receiver 104 via the at least one DCS 106 and/or the one or more direct propagation channels between the at least one transmitter 102 and the at least one receiver 104.

The one or more propagation channels g_{m,d,n} via the at least one DCS d 106 with scattering pattern α_{d}F_{d}(ϕ_{d}) are given by Equation (3). The one or more direct propagation channels h₀ may be propagation channels resulting from all paths from the at least one transmitter 102 to the at least one receiver 104 that do not propagate via the at least one DCS 106. As disclosed above the one or more propagation channels 114 may not comprise the one or more direct propagation channels between the at least one transmitter 102 and the at least one receiver 104, for example in case where the direct propagation channels are blocked and, consequently, the one or more direct propagation channels may not be estimated by the at least one receiver 104.

Besides the plurality of time slots 116, additional time slots for training, or training time slots, may also be employed. The additional or training time slots may be used for transmission of training pilots p from the at least one transmitter 102 to the at least one receiver 104 for channel estimation in the at least one receiver 104.

Then, for each time slot 116 tᵢ, with tᵢ∈{t₁, t₂, . . . , t_{T}}, the at least one receiver 104 is further configured to determine the information symbol x transmitted by the at least one transmitter 102 based on the STDC 112, based on the received coded radiofrequency signal, and based on the estimated one or more propagation channels via the at least one DCS 106 and/or the estimated one or more direct propagation channels.

That is, upon estimation of the at least one propagation channels 114, the at least one receiver 104 can proceed to decode the received STDC coded signal transmitted by the transmitter antenna n of the at least one transmitter 110 in order to obtain an estimate of each information symbol x transmitted by the transmitter antenna n of the at least one transmitter 102 or by each transmitting antenna.

Each of the at least one receiver 104 may comprise a single receiver antenna. Alternatively, one or more of the at least one receiver 104 may comprise multiple receiver antennas, and each receiver antenna may be configured to obtain by reception, during the plurality of time slots 116, the coded radiofrequency signal transmitted by the at least one transmitter 102.

The estimation of the information symbol x by the at least one receiver 104 may be based on diversity combining using the coded radiofrequency signal received by the at least one receiver antenna of the at least one receiver 104 during the total number T of the plurality of time slots 116, the estimated one or more propagation channels via the at least one DCS 106 and/or the estimated direct propagation channels, and the STDC matrix B. The diversity combining can be based on known combining procedures that have been designed for STBC communications. In case of multiple receiver antennas, diversity combining can be applied separately to each coded radiofrequency signal received by each receiver antenna separately. Furthermore, if the multiple receiver antennas are collocated or share a signal processing unit, then the signals obtained from the multiple receiver antennas can be further combined for example in a Maximum Ratio Combining (MRC) way. Thereby, the STDC 112 according to this disclosure used in conjunction with diversity combining allows to use one or more direct propagation paths and/or one or more propagation paths via the at least one DCS 106 for simplified channel estimation and information symbol estimation at the at least one receiver 104.

In this exemplary embodiment, the controller 110 is configured to determine the STDC matrix B.

Since the coded radiofrequency signal generated by the at least one transmitter 102 is based on the STDC matrix B, this matrix may need to be known by the at least one transmitter 102. Also, the STDC matrix B may need to be known at the at least one receiver 104 to decode the received coded radiofrequency signal. Further, the STDC matrix B, additionally or alternatively B_{d}, may need to be known by the at least one DCS 106. Thus, the controller is further configured to send the total number T of the plurality of time slots 116 and the STDC matrix B by signaling to the at least one transmitter 102, to the at least one receiver 104 and to the at least one DCS 106. This incurs in some overhead; however, since the STDC matrix B only has T×D elements, the overhead is small.

Additionally or alternatively, since each of the at least one DCS 106 requires only its corresponding code, the controller may be configured to send by signaling to each of the at least one DCS d 106 the respective d-th column of the STDC matrix B, B_{d}, instead of the full STDC matrix B, and the total number T of the plurality of time slots 116. Thereby, a further overhead reduction is achieved.

The controller 110 may be further configured to determine the STDC matrix B offline, and may be configured to send the STDC matrix B, additionally or alternatively the d-th column of the STDC matrix B, by signaling to the at least one transmitter 102, to the at least one receiver 104 and to the at least one DCS 106 before the at least one transmitter 102 transmits the coded radiofrequency signal to the at least one receiver 104 during the plurality of time slots 116.

In this manner, overhead may be further reduced and efficiency of the wireless communication system 100 may be enhanced.

Alternatively, the controller 110, the at least one transmitter 102, the at least one receiver 104, additionally or alternatively the at least one DCS 106 may be configured to store one or more tables comprising one or more STDC matrices B. Then, the controller 110 may be configured to send by signaling to the at least one transmitter 102, to the at least one receiver 104 and to the at least one DCS 106, a code identifier. The code identifier may comprise information that specifies a STDC matrix B of the one or more STDC matrices B in a table to be used to generate the coded radiofrequency signal transmitted from the at least one transmitter 102 to the at least one receiver 104 during a plurality of time slots 116, to control the set of scattering elements 108 of the at least one DCS 106 during the plurality of time slots 116, and to decode the coded radiofrequency signal obtained by the at least one receiver 104 during the plurality of time slots 116. The indication information may be implemented, for example, by an index that may specify the STDC matrix B of the one or more STDC matrices B in the table to be used. Consequently, the overhead for communicating the STDC matrix B can be further reduced.

Alternatively, the at least one transmitter 102 may be configured to determine the STDC matrix B. Further, the at least one transmitter 102 may be configured to send the total number T of the plurality of time slots 116 and the STDC matrix B by signaling to the controller 110, to the at least one receiver 104 and to the at least one DCS 106. Additionally or alternatively, the at least one transmitter 102 may be configured to send by signaling to each of the at least one DCS d 106 the respective d-th column of the STDC matrix B, instead of the full STDC matrix B, and the total number T of the plurality of time slots 116.

The at least one transmitter 102 may be further configured to determine the STDC matrix B offline. Then, the at least one transmitter 102 may be configured to send the STDC matrix B, additionally or alternatively the d-th column of the STDC matrix B, by signaling to the controller 110, to the at least one receiver 104 and to the at least one DCS 106 before the at least one transmitter 102 transmits the coded radiofrequency signal to the at least one receiver 104 during the plurality of time slots 116.

Each of the controller 110, the at least one transmitter 102, the at least one receiver 104, additionally or alternatively the at least one DCS 106 may be configured to store one or more tables comprising one or more STDC matrices B. Then, the at least one transmitter 102 may be configured to send by signaling to the controller 110, to the at least one receiver 104 and to the at least one DCS 106, a code identifier. The code identifier may comprise information that specifies a STDC matrix B of the one or more STDC matrices B in a table to be used. The indication information may be implemented, for example, by an index that may specify the STDC matrix B of the one or more STDC matrices B in the table to be used.

Alternatively, the at least one DCS 106 may be configured to determine the STDC matrix B. The at least one DCS 106 may be further configured to send the total number T of the plurality of time slots 116 and the STDC matrix B by signaling to the controller 110, to the at least one transmitter 102, to the at least one receiver 104, additionally or alternatively to other DCSs d 106 of the at least one DCS 106. Additionally or alternatively, the at least one DCS 106 may be configured to send by signaling to other DCSs d 106 of the at least one DCS 106 the respective d-th column of the STDC matrix B, instead of the full STDC matrix B, and the total number T of the plurality of time slots 116.

Further, the at least one DCS 106 may be configured to determine the STDC matrix B offline. Then, the at least one DCS 106 may be configured to send the STDC matrix B, additionally or alternatively the d-th column of the STDC matrix B, by signaling to the controller 110, to the at least one transmitter 102, to the at least one receiver 104, and to other DCSs 106 of the at least one DCS 106 before the at least one transmitter 102 transmits the coded radiofrequency signal to the at least one receiver 104 during the plurality of time slots 116.

Each of the controller 110, the at least one transmitter 102, the at least one receiver 104, additionally or alternatively the at least one DCS 106 may be configured to store one or more tables comprising one or more STDC matrices B. Then, the at least one DCS 106 may be configured to send by signaling to the controller 110, the at least one transmitter 102, to the at least one receiver 104 and to other DCSs 106 of the at least one DCS 106, a code identifier. The code identifier may comprise information that specifies a STDC matrix B of the one or more STDC matrices B in a table to be used. The indication information may be implemented, for example, by an index that may specify the STDC matrix B of the one or more STDC matrices B in the table to be used.

Alternatively, the at least one receiver 104 may be configured to determine the STDC matrix B. Further, the at least one receiver 104 may be configured to send the total number T of the plurality of time slots 116 and the STDC matrix B by signaling to the controller 110, to the at least one transmitter 102 and to the at least one DCS 106. Additionally or alternatively, the at least one receiver 104 may be configured to send by signaling to the at least one DCS d 106 the respective d-th column of the STDC matrix B, instead of the full STDC matrix B, and the total number T of the plurality of time slots 116.

The at least one receiver 104 may be configured to determine the STDC matrix B offline. Then, the at least one receiver 104 may be configured to send the STDC matrix B, additionally or alternatively the d-th column of the STDC matrix B, by signaling to the controller 110, to the at least one transmitter 102 and to the at least one DCS 106 before the at least one transmitter 102 transmits the coded radiofrequency signal to the at least one receiver 104 during the plurality of time slots 116.

Each of the controller 110, the at least one transmitter 102, the at least one receiver 104 and/or the at least one DCS 106 may be configured to store one or more tables comprising one or more STDC matrices B. Then, the at least one receiver 104 may be configured to send by signaling to the controller 110, to the at least one transmitter 102 and to the at least one DCS 106, a code identifier. The code identifier may comprise information that specifies a STDC matrix B of the one or more STDC matrices B in a table to be used. The indication information may be implemented, for example, by an index that may specify the STDC matrix B of the one or more STDC matrices B in the table to be used.

The STDC 112 according to this disclosure may be applied, for example, for scaling a DCS scattering pattern by a complex scalar. A conventional model of the scattering pattern F_{d} (ϕ_{d}) for a DCS d of the at least one DCS 106 with S_{d} scattering elements 108 is given such as provided in Equation (4):

$${F}_{d} ( {ϕ}_{d} ) = diag ( {σ}_{d , 1} {e}^{j {ϕ}_{d , 1}} , {σ}_{d , 2} {e}^{j {ϕ}_{d , 2}} , … , {σ}_{d , δ} {e}^{j {ϕ}_{d , δ}} , … , {σ}_{d , {S}_{d}} {e}^{j {ϕ}_{d , {S}_{d}}} ) , \qquad ( 4 )$$

where the base phase shift configuration matrix of the DCS d is ϕ_{d}=[ϕ_{d,1}, ϕ_{d,2}, . . . , ϕ_{d,} [symbol] , . . . , ϕ_{d,S}_{_{d}}], ϕ_{d,} [symbol] is the scattering phase of the scattering element [symbol] 108 of the DCS d 106, and σ_{d,} [symbol] represents a scattering amplitude due to the scattering element [symbol] _{d} 108, which is related, for example, to the radar cross section of the scattering element 108.

Given a complex scalar

$${α}_{d} = {γ}_{d} {e}^{j {θ}_{d}} ,$$

scaling the scattering pattern F_{d} (ϕ_{d}) of a DCS d 106 by aa is obtained by applying a new phase matrix ϕ_{d}^{new} to the scattering elements 108 of the at least one DCS d 106 as shown in Equation (5) and a new scaling of the scattering amplitude to the scattering elements 108 of the DCS d given in Equation (6):

$$\begin{matrix}{ϕ}_{d}^{new} = [ {ϕ}_{d , 1}^{new} , {ϕ}_{d , 2}^{new} , … , {ϕ}_{d , δ}^{new} , … , {ϕ}_{d , {S}_{d}}^{new} ] \\ = [ {ϕ}_{d , 1} + {θ}_{d} , {ϕ}_{d , 2} + {θ}_{d} , … , {ϕ}_{d , δ} + {θ}_{d} , … , {ϕ}_{d , {S}_{d}} + {θ}_{d} ] \\ = {ϕ}_{d} - {θ}_{d}\end{matrix} \qquad ( 5 )$$

$$and$$

$${σ}_{d , 1}^{new} = {γ}_{d} {σ}_{d , 1} , {σ}_{d , 2}^{new} = {γ}_{d} {σ}_{d , 2} , … , {σ}_{d , δ}^{new} = {γ}_{d} {σ}_{d , δ} , … , {σ}_{d , {S}_{d}}^{new} = {γ}_{d} {σ}_{d , {S}_{d}} \qquad ( 6 )$$

Applying the phase in Equation (5) and the amplitude scaling in Equation (6) to the DCS elements results in a new scattering pattern given in Equation (7):

$$\begin{matrix}{F}_{d}^{new} ( {ϕ}_{d}^{new} ) = diag ( {σ}_{d , 1}^{new} {e}^{j {ϕ}_{d , 1}^{new}} , {σ}_{d , 2}^{new} {e}^{j {ϕ}_{d , 2}^{new}} , … , {σ}_{d , δ}^{new} {e}^{j {ϕ}_{d , δ}^{new}} , … , {σ}_{d , {S}_{d}}^{new} {e}^{j {ϕ}_{d , {S}_{d}}^{new}} ) \\ = diag ( {γ}_{d} {σ}_{d , 1} {e}^{j ( {ϕ}_{d , 1} + {θ}_{d} )} , {γ}_{d} {σ}_{d , 2} {e}^{j ( {ϕ}_{d , 2} + {θ}_{d} )} , … , {γ}_{d} {σ}_{d , δ} {e}^{j ( {ϕ}_{d , δ} + {θ}_{d} )} , … , {γ}_{d} {σ}_{d , {S}_{d}} {e}^{j ( {ϕ}_{d , {S}_{d}} + {θ}_{d} )} ) \\ = {γ}_{d} {e}^{j {θ}_{d}} diag ( {σ}_{d , 1} {e}^{j {ϕ}_{d , 1}} , {σ}_{d , 2} {e}^{j {ϕ}_{d , 2}} , … , {σ}_{d , δ} {e}^{j {ϕ}_{d , δ}} , … , {σ}_{d , {S}_{d}} {e}^{j {ϕ}_{d , {S}_{d}}} ) \\ = {γ}_{d} {e}^{j {θ}_{d}} {F}_{d} ( {ϕ}_{d} ) \\ = {α}_{d} {F}_{d} ( {ϕ}_{d} )\end{matrix} \qquad ( 7 )$$

As can be observed from Equation (7) above, the new scattering pattern is the scattering pattern F_{d} (ϕ_{d}) scaled by α_{d}, as disclosed above.

In another example, the STDC 112 may be applied for scaling a DCS scattering pattern by the conjugate of a complex scalar. Given a complex scalar

$${α}_{d} = {γ}_{d} {e}^{j {θ}_{d}} ,$$

scaling a scattering pattern F_{d} (ϕ_{d}) of a DCS d 106 by α*_{d} is obtained in a similar manner as Equation (5) and Equation (6) above, but instead of adding a phase θ_{d} to the base phase shift configuration matrix ϕ_{d}, a phase −θ_{d} is added as shown in Equation (8):

$$\begin{matrix}{ϕ}_{d}^{new} = [ {ϕ}_{d , 1}^{new} , {ϕ}_{d , 2}^{new} , … , {ϕ}_{d , δ}^{new} , … , {ϕ}_{d , {S}_{d}}^{new} ] \\ = [ {ϕ}_{d , 1} - {θ}_{d} , {ϕ}_{d , 2} - {θ}_{d} , … , {ϕ}_{d , δ} - {θ}_{d} , … , {ϕ}_{d , {S}_{d}} - {θ}_{d} ] \\ = {ϕ}_{d} - {θ}_{d}\end{matrix} \qquad ( 8 )$$

With the new phases as described in Equation (8) and the new scaling as defined above in Equation (6), the new scattering pattern obtained is given in Equation (9):

$$\begin{matrix}{F}_{d}^{new} ( {ϕ}_{d}^{new} ) = diag ( {σ}_{d , 1}^{new} {e}^{j {ϕ}_{d , 1}^{new}} , {σ}_{d , 2}^{new} {e}^{j {ϕ}_{d , 2}^{new}} , … , {σ}_{d , δ}^{new} {e}^{j {ϕ}_{d , δ}^{new}} , … , {σ}_{d , {S}_{d}}^{new} {e}^{j {ϕ}_{d , {S}_{d}}^{new}} ) \\ = diag ( {γ}_{d} {σ}_{d , 1} {e}^{j ( {ϕ}_{d , 1} - {θ}_{d} )} , {γ}_{d} {σ}_{d , 2} {e}^{j ( {ϕ}_{d , 2} - {θ}_{d} )} , … , {γ}_{d} {σ}_{d , δ} {e}^{j ( {ϕ}_{d , δ} + - {θ}_{d} )} , … , {γ}_{d} {σ}_{d , {S}_{d}} {e}^{j ( {ϕ}_{d , {S}_{d}} - {θ}_{d} )} ) \\ = {γ}_{d} {e}^{- j {θ}_{d}} diag ( {σ}_{d , 1} {e}^{j {ϕ}_{d , 1}} , {σ}_{d , 2} {e}^{j {ϕ}_{d , 2}} , … , {σ}_{d , δ} {e}^{j {ϕ}_{d , δ}} , … , {σ}_{d , {S}_{d}} {e}^{j {ϕ}_{d , {S}_{d}}} ) \\ = {γ}_{d} {e}^{- j {θ}_{d}} {F}_{d} ( {ϕ}_{d} ) \\ = {α}_{d}^{*} {F}_{d} ( {ϕ}_{d} ) ,\end{matrix}$$

which is the scattering pattern F_{d} (ϕ_{d}) scaled by the conjugate of α_{d}.

In a further example, the STDC 112 may be applied for scaling a DCS scattering pattern by the negative conjugate of a complex scalar. Given a complex scalar

$${α}_{d} = {γ}_{d} {e}^{j {θ}_{d}} ,$$

scaling a scattering pattern F_{d} (ϕ_{d}) of a DCS d 106 by −α*_{d} is obtained in a similar manner as in Equation (5) and Equation (6) above but instead of adding a phase θ_{d} to the base phase shift configuration matrix ϕ_{d}, a phase −θ_{d}+π is added, as shown in Equation (10):

$$\begin{matrix}{ϕ}_{d}^{new} = [ {ϕ}_{d , 1}^{new} , {ϕ}_{d , 2}^{new} , … , {ϕ}_{d , δ}^{new} , … , {ϕ}_{d , {S}_{d}}^{new} ] \\ = [ {ϕ}_{d , 1} - {θ}_{d} + π , {ϕ}_{d , 2} - {θ}_{d} + π , … , {ϕ}_{d , δ} - {θ}_{d} + π , … , {ϕ}_{d , {S}_{d}} - {θ}_{d} + π ] \\ = {ϕ}_{d} - {θ}_{d} + π .\end{matrix} \qquad ( 10 )$$

With the new phases as described in Equation (10) above and the new scaling as defined in Equation (6), the new obtained scattering pattern is given by Equation (11):

$$\begin{matrix}{F}_{d}^{new} ( {ϕ}_{d}^{new} ) = diag ( {σ}_{d , 1}^{new} {e}^{j {ϕ}_{d , 1}^{new}} , {σ}_{d , 2}^{new} {e}^{j {ϕ}_{d , 2}^{new}} , … , {σ}_{d , δ}^{new} {e}^{j {ϕ}_{d , δ}^{new}} , … , {σ}_{d , {S}_{d}}^{new} {e}^{j {ϕ}_{d , {S}_{d}}^{new}} ) \\ = diag ( {γ}_{d} {σ}_{d , 1} {e}^{j ( {ϕ}_{d , 1} - {θ}_{d} + π )} , {γ}_{d} {σ}_{d , 2} {e}^{j ( {ϕ}_{d , 2} - {θ}_{d} + π )} , … , {γ}_{d} {σ}_{d , δ} {e}^{j ( {ϕ}_{d , δ} - {θ}_{d} + π )} , … , {γ}_{d} {σ}_{d , {S}_{d}} {e}^{j ( {ϕ}_{d , {S}_{d}} - {θ}_{d} + π )} ) \\ = {γ}_{d} {e}^{- j {θ}_{d} + j π} diag ( {σ}_{d , 1} {e}^{j {ϕ}_{d , 1}} , {σ}_{d , 2} {e}^{j {ϕ}_{d , 2}} , … , {σ}_{d , δ} {e}^{j {ϕ}_{d , δ}} , … , {σ}_{d , {S}_{d}} {e}^{j {ϕ}_{d , {S}_{d}}} ) \\ = {γ}_{d} {e}^{- j {θ}_{d} + j π} {F}_{d} ( {ϕ}_{d} ) \\ = {γ}_{d} {e}^{- j {θ}_{d}} {F}_{d} ( {ϕ}_{d} ) \\ = - {α}_{d}^{*} {F}_{d} ( {ϕ}_{d} )\end{matrix}$$

that is the scattering pattern of the at least one DCS d 106, F_{d} (ϕ_{d}), scaled by the negative conjugate of α_{d}.

The above examples for a DCS pattern scaling consider scaling by a complex scalar and, hence, modify the scattering amplitude and phase of the scattering unit elements 108 of the at least one DCS 106. However, having the scattering elements 108 of the at least one DCS 106 with controllable scattering amplitude is challenging, and therefore most of the known DCS configurations are for DCSs that only provide scattering phase control. In cases where only the scattering phase of the scattering elements 108 of the at least one DCS 106 can be controlled, a procedure as described in the examples above applies by simply setting γ_{d}=1.

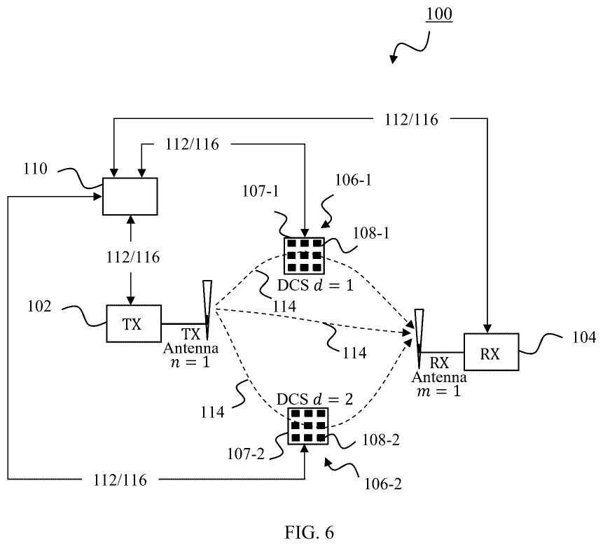

FIG. 6 shows a schematic diagram of an example of a wireless communication system 100, which builds on the exemplary embodiment of shown in FIG. 4. Same elements are labelled with the same reference signs. In this example, the wireless communication system 100 may comprise the controller 110, one transmitter 102 with one transmitter antenna, one receiver with one receiver antenna 104 and two DCSs 106-1, 106-2. Each DCS 106-1, 106-2 may comprise a scattering surface 107-1, 107-2, and each scattering surface 107-1, 107-2 may comprise a set of scattering elements 108-1, 108-2.

The controller 110 may be configured to determine the STDC 112, that is, the controller 110 may be configured to determine the STDC matrix B. In this example, the total number of DCS is D=2 and it may be considered that Tₘₐₓ=2 and δ=2, which meets the requirement of δ≤D. A well-known STBC matrix that maps two complex values {β₁, β_{δ=2}} onto a T×D matrix B such that T≤Tₘₐₓ is the 2×2 Alamouti STBC matrix, given in Equation (12):

$$B = [ \begin{matrix}{β}_{1} & {β}_{2} \\ - {β}_{2}^{*} & {β}_{1}^{*}\end{matrix} ] . \qquad ( 12 )$$

This matrix B meets the constraint that the entries of a given row belong either to {±β₁, ±β₂, 0} or to {±β*₁, ±β*₂, 0} but not to both. This is easily verifiable by inspection, since the entries of row 1 of the matrix B given in Equation (12) are {β₁, β₂}∈{±β₁, ±β₂, 0} and the entries of row 2 of matrix B are {β*₁, −β*₂}∈{±β*₁, ±β*₂, 0}. In this example, β₁ and β₂ are generally expressed as scalar complex values, and specific values for β₁ and β₂ are not assigned.

Then, the controller 110 may be configured to choose the Alamouti matrix B of Equation (12) as the STDC matrix B.

Further, the controller 110 may be configured to send the total number T of the plurality of time slots 116 and the STDC matrix B by signaling to the transmitter 102, to the receiver 104 and to the DCSs 106-1, 106-2. Alternatively, instead of the full STDC matrix B, the controller 110 may send by signaling to each of the DCSs 106-1, 106-2 the respective d-th column of the STDC matrix B.

The controller 110 may be configured to determine the STDC matrix B offline, and may send the STDC matrix B, additionally or alternatively the d-th column of the STDC matrix B, by signaling to the transmitter 102, to the receiver 104 and to the DCSs 106-1, 106-2 before the transmitter 102 transmits the coded radiofrequency signal to the receiver 104 during the plurality of time slots 116.

Alternatively, the controller 110, the transmitter 102, the receiver 104, additionally or alternatively the DCSs 106-1, 106-2 may be configured to store one or more tables comprising one or more STDC matrices B. Then, the controller 110 may be configured to send by signaling to the transmitter 102, to the receiver 104 and to the DCSs 106-1, 106-2, a code identifier. The code identifier may comprise information that specifies a STDC matrix B of the one or more STDC matrices B in a table to be used. The indication information may be implemented, for example, by an index that may specify the STDC matrix B of the one or more STDC matrices B in the table to be used.

The controller 110 may be further configured to determine the base phase shift configuration matrices ϕ₁, ϕ₂ for each DCS 106-1, 106-2 respectively. The base phase shift configuration matrices ϕ₁, ϕ₂ may be obtained by the controller 110 via any arbitrary, or random fashion or from a predefined list or using any available previous knowledge about the DCSs 106-1, 106-2.

Then, the controller 110 may control, based on the STDC 112, the set of scattering elements 108-1, 108-2 of the DCS 106-1, 106-2 during the T=2 time slots 116. That is, for each time slot 116 tᵢ∈{t₁, t₂} of the T=2 time slots, the controller 110 may be configured to determine the coded configuration for the DCS d, with d=1, 2, by setting a scattering pattern equal to B_{i,d} F_{d} (ϕ_{d})=α_{d} F_{d} (ϕ_{d}), with α_{d}=B_{i,d}, where B_{i,d} is the entry in the i-th row and d-th column of matrix B as disclosed above, and F_{d} (ϕ_{d}) is the scattering pattern of each DCS d 106-1, 106-2.

Alternatively, the controller 110 may control each DCS 106-1, 106-2 to choose the respective code B_{d} and to determine the respective coded configuration.

For the STDC matrix B defined in Equation (12), for the time slot t₁, the code for the DCS d=1 106-1 is determined by the first entry of the respective code B₁, i.e., the entry in the first row and the first column of the STDC matrix B provided in Equation (12) sets α₁=β₁; thus, the controller 110 may be configured to determine the coded configuration for the DCS d=1 106-1, as B_{1,1} F₁ (ϕ₁), which is equal to β₁ F₁ (ϕ₁). At time slot t₁, the code for the DCS d=2 106-2 is determined by the first entry of the respective code B₂, and the controller 110 may determine the coded configuration for the DCS d=2 106-2 as B_{1,2} F₂ (ϕ₂) that is equal to B₂ F₂ (ϕ₂), where β₂ is the first entry of the respective code B₂, i.e., the entry in the first row and the second column of the STDC matrix B in Equation (12) sets α₂=β₂.

Further, for the time slot t₂, the code for the DCS d=1 106-1 is determined by the second entry of B₁, the entry in the second row and the first column of the STDC matrix B in Equation (12) sets α₁=−β*₂; thus the coded configuration or scattering pattern is B_{2,1} F₁ (ϕ₁)=−β*₂F₁ (ϕ₁). Similarly, for the time slot t₂, the code for the DCS d=2 106-2 is determined by the second entry of B₂, the entry in the second row and the second column of the STDC matrix B in Equation (12) sets α₂=β*₁, and the coded configuration or scattering pattern for the DCS d=2 106-2 is B_{2,2}F₂ (ϕ₂)=β*₁F₂(ϕ₂). The resulting coded configuration for each time slot 116 and for each DCS 106-1, 106-2 is shown in Table 1.

TABLE 1

| | Scattering Pattern | Scattering Pattern |
|---|---|---|
| | DCS 1 | DCS 2 |
| | α₁F₁(ϕ₁) | α₂F₂(ϕ₂) |
| Time slot t₁ | β₁F₁(ϕ₁) | β₂F₂(ϕ₂) |
| Time slot t₂ | −β₂*F₁(ϕ₁) | β₁*F₂(ϕ₂) |

In this example with a single transmitter 101 and a single receiver 104, each with a single antenna respectively hence n=1 and m=1, the one or more propagation channels via the two DCSs 106-1, 106-2 are denoted as h₁=h_{1,1,1} and h₂=h_{1,2,1}, which are based on Equation (1), are defined as Equation (13) and Equation (14):

$${h}_{1} = {h}_{1 , 1 , 1} = {h}_{{DCS}_{1} \to {RX}_{1}}^{T} {F}_{1} ( {ϕ}_{1} ) {h}_{{TX}_{1} \to {DCS}_{1}} , \qquad ( 13 )$$

$${h}_{2} = {h}_{1 , 2 , 1} = {h}_{{DCS}_{2} \to {RX}_{1}}^{T} {F}_{2} ( {ϕ}_{2} ) {h}_{{TX}_{1} \to {DCS}_{2}} . \qquad ( 14 )$$

Using Equation (3), which defines that for a DCS d with scattering pattern equal to α_{d} F_{d} (ϕ_{d}), the resulting propagation channel via the DCS d from the at least one transmitter 102 n=1 to the at least one receiver 104 m=1 is g_{1,d,1}=α_{d}h_{1,d,1}. Further, for brevity of notation, it is defined g₁=g_{1,1,1}=α₁h_{1,1,1}=α₁h₁ and g₂=9_{1,2,1}=α₂h_{1,2,1}=α₂h₂. The expressions for the propagation channels via each DCS 106-1, 106-2 are shown in Table 2.

TABLE 2

| | Channel via | Channel via |
|---|---|---|
| | DCS 1 | DCS 2 |
| | g₁ = α₁h₁ | g₂ = α₂h₂ |
| Time slot t₁ | β₁h₁ | β₂h₂ |
| Time slot t₂ | −β₂*h₁ | β₁*h₂ |

As it can be seen from Table 2, the value of α_{d} changes as a function of the STDC 112 that is specified by the δ≤ D complex values {β₁, β₂, . . . , β_{δ}} of the STDC matrix B and, thus, provides channel programming with STDC 112 having the controlled channel variations shown in Table 2.

Then, the controller 110 may be configured to control, based on the STDC 112, the transmitter 102 to generate the coded radiofrequency signal. That is, for each time slot 116 tᵢ, the transmitter 102 may be configured to transmit an information symbol x in the coded radiofrequency signal. The coded radiofrequency signal may comprise the transformation of the information symbol x based on the STDC matrix B, f_{TX} (x, B, tᵢ). For the time slot t₁, since the entries of the first row of matrix B given in Equation (12) are {β₁, β₂}∈{±β₁, ±β₂, 0}, then the transmitter 102 may be configured to send the symbol x at time slot t₁. For time slot t₂, since the entries of the second row of matrix B are {β*₁, −β*₂}∈{±β*₁, ±β*₂, 0} then the transmitter 102 may be configured to send the symbol x*. The transmitted symbol for each time slot 116 is summarized in Table 3.

TABLE 3

| | Transmitted |
|---|---|
| | symbol |
| Time slot t₁ | x |
| Time slot t₂ | x* |

In the example of FIG. 6, the transmitter 102 may be further configured, based on the STDC 112, to transmit training pilots p during additional or training time slots. Said training pilots p sent during the training time slots may be needed for the receiver 104 in order to estimate the one or more propagation channels 114, in case that the estimates of the one or more propagation channels via the at least one DCS and/or one or more direct propagation channels are not yet available at the receiver 104.

Table 4 shows the coded signal transmitted by the transmitter 102 including the extra time slots for transmission of training pilots p for channel estimation, and the time slots t₁ and t₂ 116 for transmission of the coded signal transmitted by the transmitter 102 (or the transformation of the information symbol sent by the transmitter 102). The value of α_{d} for each DCS 106-1, 106-2 is also shown in Table 4. As explained above, during the two time slots 116 t₁, t₂, α_{d} depends on the STDC matrix B. During the additional time slots for training, the controller 110 may be configured to control the set of scattering elements 108-1, 108-2 of the DCSs 106-1 106-2 by setting values of α_{d}, for example, in a predetermined manner. The resulting direct propagation channels, denoted as h₀ between the transmitter 102 and the receiver 104, the propagation channels via the two DCSs 106-1 106-2 h₁ and h₂, as well as the coded radiofrequency signal received by the receiver 104 are also included in Table 4.

TABLE 4

| | | | | | Channel | Channel | |
|---|---|---|---|---|---|---|---|
| | Transmitted | | | Direct | via DCS 1 | via DCS 2 | |
| | symbol | α₁ | α₂ | channel | g₁ | g₂ | Received signal |
| Training | p | 1 | 1 | h₀ | h₁ | h₂ | yₚ_{₁} = |
| time slot | | | | | | | (h₀ + h₁ + h₂)p |
| Training | p | 1 | −1 | h₀ | h₁ | −h₂ | yₚ_{₂} = |
| time slot | | | | | | | (h₀ + h₁ − h₂)p |
| Training | p | −1 | −1 | h₀ | −h₁ | −h₂ | yₚ_{₃} = |
| time slot | | | | | | | (h₀ − h₁ − h₂)p |
| Time slot | x | β₁ | β₂ | h₀ | β₁h₁ | β₂h₂ | yₜ_{₁} = |
| t₁ | | | | | | | (h₀ + β₁h₁ + β₂h₂)x |
| Time slot | x* | −β₂* | β₁* | h₀ | −β₂*h₁ | β₁*h₂ | yₜ_{₂} = |
| t₂ | | | | | | | (h₀ − β₂*h₁ + β₁*h₂)x* |

The transmitted pilots p may be known at the receiver 104. Then, for each training time slot the receiver 104 may be configured to estimate the one or more propagation channels via the DCS 106-1, 106-2, h₁, h₂, additionally or alternatively to estimate the one or more direct propagation channels h₀ , based on the received training pilots p and on the received signals yₚ_{₁}, yₚ_{₂} and yₚ_{₃}. These channels are just scalars, so their estimation is easier compared to estimating channels whose sizes depend on the number of scattering elements 108-1, 108-2 of each DCS 106-1 106-2, as it is the case in customary algorithms that use DCSs.

Further, the receiver 104 may be configured to determine the information symbol x transmitted by the transmitter 102 based on the STDC 112, based on the received coded radiofrequency signals during the time slots 116 and based on the estimated one or more propagation channels via the at least one DCS 106, additionally or alternatively the estimated one or more direct propagation channels.

To that end, the receiver 104 may proceed as follows. The received signal vector y is constructed by stacking the signal received at the first time slot, namely yₜ_{₁} and using the conjugate of the signal received at the second time slot, namely

$${y}_{{t}_{2}}^{*} .$$

The signal received in the second time slot is conjugated because the information symbol transmitted in the second time slot was sent as the conjugate x*. Following this approach, in the present disclosure the received signal vector y may be expressed as provided in Equation (15):

$$y = [ \begin{matrix}{y}_{{t}_{1}} \\ {y}_{{t}_{2}}^{*}\end{matrix} ] = [ \begin{matrix}{h}_{1} & {h}_{2} & {h}_{0} \\ {h}_{2}^{*} & - {h}_{1}^{*} & {h}_{0}^{*}\end{matrix} ] [ \begin{matrix}{β}_{1} x \\ {β}_{2} x \\ x\end{matrix} ] . \qquad ( 15 )$$

Since the one or more propagation channels h₀, h₁ and h₂ have been estimated by the receiver 104, an overall channel matrix H can be constructed as in Equation (16):

$$H = [ \begin{matrix}{h}_{1} & {h}_{2} & {h}_{0} \\ {h}_{2}^{*} & - {h}_{1}^{*} & {h}_{0}^{*}\end{matrix} ] . \qquad ( 16 )$$

The channel matrix H can be used to write a received signal vector as in Equation (17):

$$y = H [ \begin{matrix}{β}_{1} x \\ {β}_{2} x \\ x\end{matrix} ] . \qquad ( 17 )$$

Then, a combining matrix Q can be computed as in Equation (18):

$$Q = {H}^{*} = [ \begin{matrix}{h}_{1}^{*} & {h}_{2} \\ {h}_{2}^{*} & - {h}_{1} \\ {h}_{0}^{*} & {h}_{0}\end{matrix} ] \qquad ( 18 )$$

where H*is used to denote the transpose conjugate of H, and by applying this matrix to the received signal vector y, Equation (19) is obtained:

$$\begin{matrix}Qy = [ \begin{matrix}{h}_{1}^{*} & {h}_{2} \\ {h}_{2}^{*} & - {h}_{1} \\ {h}_{0}^{*} & {h}_{0}\end{matrix} ] [ \begin{matrix}{h}_{1} & {h}_{2} & {h}_{0} \\ {h}_{2}^{*} & - {h}_{1}^{*} & {h}_{0}^{*}\end{matrix} ] [ \begin{matrix}{β}_{1} x \\ {β}_{2} x \\ x\end{matrix} ] \\ = [ \begin{matrix}{β}_{1} ( {\vert {h}_{1} \vert}^{2} + {\vert {h}_{2} \vert}^{2} ) & 0 & {h}_{1}^{*} {h}_{0} + {h}_{2} {h}_{0}^{*} \\ 0 & {β}_{2} ( {\vert {h}_{1} \vert}^{2} + {\vert {h}_{2} \vert}^{2} ) & {h}_{2}^{*} {h}_{0} - {h}_{1} {h}_{0}^{*} \\ {β}_{1} ( {h}_{0}^{*} {h}_{1} + {h}_{0} {h}_{2}^{*} ) & {β}_{2} ( {h}_{0}^{*} {h}_{2} - {h}_{0} {h}_{1}^{*} ) & 2 {\vert {h}_{0} \vert}^{2}\end{matrix} ] [ \begin{matrix}x \\ x \\ x\end{matrix} ]\end{matrix} . \qquad ( 19 )$$

The diagonal terms in Equation (19) show that the received and combined signals using the combining matrix Q given in Equation (18) offer diversity combining of direct paths between the transmitter 102 and the receiver 104 and paths between the transmitter 102 and the receiver 104 via the DCSs 106-1, 106-2. The diagonal terms contribute to coherent combining contributions of the direct paths and the paths via the DCSs 106-1, 106-2.

Since the STDC matrix B and its complex values β₁ and β₂ may be known at the receiver 104, the receiver 104 can be configured to construct a normalizing matrix as in Equation (20):

$$N = diag ( \frac{1}{{β}_{1} ( {\vert {h}_{1} \vert}^{2} + {\vert {h}_{2} \vert}^{2} )} , \frac{1}{{β}_{2} ( {\vert {h}_{1} \vert}^{2} + {\vert {h}_{2} \vert}^{2} )} , \frac{1}{2 {\vert {h}_{0} \vert}^{2}} ) . \qquad ( 20 )$$

Using the received signal vector y, the combining matrix Q and the normalizing matrix N, the receiver 104 may obtain three initial estimates \hat{x}_{init,1}, \hat{x}_{init,2}, \hat{x}_{init,3} of the information symbol x transmitted by the transmitter 102 in the coded radiofrequency signal, given in Equation (21):

$$\begin{matrix}[ \begin{matrix}{\hat{x}}_{init , 1} \\ {\hat{x}}_{init , 2} \\ {\hat{x}}_{init , 3}\end{matrix} ] = NQy \\ = N [ \begin{matrix}{\vert {h}_{1} \vert}^{2} + {\vert {h}_{2} \vert}^{2} & 0 & {h}_{1}^{*} {h}_{0} + {h}_{2} {h}_{0}^{*} \\ 0 & {\vert {h}_{1} \vert}^{2} + {\vert {h}_{2} \vert}^{2} & {h}_{2}^{*} {h}_{0} - {h}_{1} {h}_{0}^{*} \\ {h}_{0}^{*} {h}_{1} + {h}_{0} {h}_{2}^{*} & {h}_{0}^{*} {h}_{2} - {h}_{0} {h}_{1}^{*} & 2 {\vert {h}_{0} \vert}^{2}\end{matrix} ] [ \begin{matrix}{β}_{1} x \\ {β}_{2} x \\ x\end{matrix} ] \\ = [ \begin{matrix}1 & 0 & \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} \\ 0 & 1 & \frac{{g}_{2}^{*} {h}_{0} - {g}_{1} {h}_{0}^{*}}{{β}_{2} ( {\vert {h}_{1} \vert}^{2} + {\vert {h}_{2} \vert}^{2} )} \\ \frac{{β}_{1} ( {h}_{0}^{*} {h}_{1} + {h}_{0} {h}_{2}^{*} )}{2 {\vert {h}_{0} \vert}^{2}} & \frac{{β}_{2} ( {h}_{0}^{*} {h}_{2} - {h}_{0} {h}_{1}^{*} )}{2 {\vert {h}_{0} \vert}^{2}} & 1\end{matrix} ] [ \begin{matrix}x \\ x \\ x\end{matrix} ]\end{matrix} . \qquad ( 21 )$$

The three initial estimates can be combined in order to obtain the final estimate of x as in Equation (22):

$$\begin{matrix}\hat{x} = \frac{{\hat{x}}_{init , 1} + {\hat{x}}_{init , 2} + {\hat{x}}_{init , 3}}{3} \\ = x + \frac{1}{3} ( \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} + \frac{{h}_{2}^{*} {h}_{0} - {h}_{1} {h}_{0}^{*}}{{β}_{2} ( {\vert {h}_{1} \vert}^{2} + {\vert {h}_{2} \vert}^{2} )} + \\ \frac{{β}_{1} ( {h}_{0}^{*} {h}_{1} + {h}_{0} {h}_{2}^{*} )}{2 {\vert {h}_{0} \vert}^{2}} + \frac{{β}_{2} ( {h}_{0}^{*} {h}_{2} - {h}_{0} {h}_{1}^{*} )}{2 {\vert {h}_{0} \vert}^{2}} ) x \\ = x + zx\end{matrix} \qquad ( 22 )$$

where the scaling term z is given by Equation (23):

$$Z = \frac{1}{3} ( \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} + \frac{{h}_{2}^{*} {h}_{0} - {h}_{1} {h}_{0}^{*}}{{β}_{2} ( {\vert {h}_{1} \vert}^{2} + {\vert {h}_{2} \vert}^{2} )} + \frac{{β}_{1} ( {h}_{0}^{*} {h}_{1} + {h}_{0} {h}_{2}^{*} )}{2 {\vert {h}_{0} \vert}^{2}} + \frac{{β}_{2} ( {h}_{0}^{*} {h}_{2} - {h}_{0} {h}_{1}^{*} )}{2 {\vert {h}_{0} \vert}^{2}} ) . \qquad ( 23 )$$

The noise term zx depends on both the information symbol x and the scaling term z. Since the propagation channels h₀, h₁ and h₂ may be independent and random, their combination as in the expression (23) for z is expected to result in a variable with zero mean distribution as z˜ [symbol] (0, v_{z}), where [symbol] (0, v_{z}) is a Gaussian distribution with mean zero and variance v_{z} which will depend on the channel statistics and the combination of terms in Equation (23).

If the direct propagation channels h₀ is much weaker than the propagation channels via the DCSs 106-1, 106-2, as it is customarily considered in DCSs, and as can be assessed after the channel estimation, then the receiver 104 may not take into account the terms proportional to h₀ and the combining matrix Q is simplified as shown in Equation (24):

$$Q = [ \begin{matrix}{h}_{1}^{*} & {h}_{2} \\ {h}_{2}^{*} & - {h}_{1}\end{matrix} ] \qquad ( 24 )$$

and the normalization matrix takes the form of Equation (25):

$$N = diag ( \frac{1}{{β}_{1} ( {\vert {h}_{1} \vert}^{2} + {\vert {h}_{2} \vert}^{2} )} , \frac{1}{{β}_{2} ( {\vert {h}_{1} \vert}^{2} + {\vert {h}_{2} \vert}^{2} )} ) . \qquad ( 25 )$$

Thereby, the initial estimates are given by Equation (26):

$$\begin{matrix}[ \begin{matrix}{\hat{x}}_{init , 1} \\ {\hat{x}}_{init , 2}\end{matrix} ] = {NQ}^{*} y \\ = N [ \begin{matrix}{\vert {h}_{1} \vert}^{2} + {\vert {h}_{2} \vert}^{2} & 0 & {h}_{1}^{*} {h}_{0} + {h}_{2} {h}_{0}^{*} \\ 0 & {\vert {h}_{1} \vert}^{2} + {\vert {h}_{2} \vert}^{2} & {h}_{2}^{*} {h}_{0} - {h}_{1} {h}_{0}^{*}\end{matrix} ] [ \begin{matrix}{β}_{1} x \\ {β}_{2} x \\ x\end{matrix} ] \\ = [ \begin{matrix}1 & 0 & \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} \\ 0 & 1 & \frac{{h}_{2}^{*} {h}_{0} - {h}_{1} {h}_{0}^{*}}{{β}_{2} ( {\vert {h}_{1} \vert}^{2} + {\vert {h}_{2} \vert}^{2} )}\end{matrix} ] [ \begin{matrix}x \\ x \\ x\end{matrix} ]\end{matrix} , \qquad ( 26 )$$

and the final estimate of the information symbol x is given by Equation (27):

$$\begin{matrix}\hat{x} = \frac{{\hat{x}}_{init , 1} + {\hat{x}}_{init , 2} -}{2} \\ = x + \frac{1}{2} ( \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} + \frac{{h}_{2}^{*} {h}_{0} - {h}_{1} {h}_{0}^{*}}{{β}_{2} ( {\vert {h}_{1} \vert}^{2} + {\vert {h}_{2} \vert}^{2} )} ) x \\ = x + zx\end{matrix} \qquad ( 27 )$$

where the term z is given by Equation (28):

$$z = \frac{1}{2} ( \frac{{h}_{1}^{*} {h}_{0} + {h}_{2} {h}_{0}^{*}}{{β}_{1} ( {\vert {h}_{1} \vert}^{2} + {\vert {h}_{2} \vert}^{2} )} + \frac{{h}_{2}^{*} {h}_{0} - {h}_{1} {h}_{0}^{*}}{{β}_{2} ( {\vert {h}_{1} \vert}^{2} + {\vert {h}_{2} \vert}^{2} )} ) . \qquad ( 28 )$$

In this case, since h₀ is weak and since h₀ or its conjugate h*₀ multiplies each of the terms in Equation (28), then z given by Equation (28) is also expected to be weak. In other words, the term zx is much smaller than x, which further facilitates improving the estimate of the information symbol x from Equation (27).

Optionally, Additive White Gaussian Noise (AWGN), which is always present in a received signal, may be added to the received signal vector in Equation (15) in order to estimate the information symbol x. Thereby, the processing for combining with Q, normalizing with N and combining the initial estimates to obtain the final estimate of x as disclosed above, also takes into account additional noise terms having lower magnitude than x.

In this example, as explained above, β₁ and β₂ have been considered as having a general, complex value. The value of β₁ and β₂ may be assigned depending on the capabilities or properties of the at least one DCS 106-1, 106-2. For example, for DCSs that only provide control of scattering phase shifts, the values of β₁ and β₂ may be of unit magnitude. Given specific values of β₁ and β₂, further simplifications or modifications of the channel estimation and of the estimation of the information symbol x at the at least one receiver 104 can be implemented.

In a further example, the at least one receiver 104 may combine the received signals by processing the received signal vector y of Equation (15) via a pseudoinverse of H, denoted by H^{†} and may further compute the initial estimates as in Equation (29):

$$[ \begin{matrix}{\hat{x}}_{init , 1} \\ {\hat{x}}_{init , 2} \\ {\hat{x}}_{init , 3}\end{matrix} ] = {H}^{†} y . \qquad ( 29 )$$

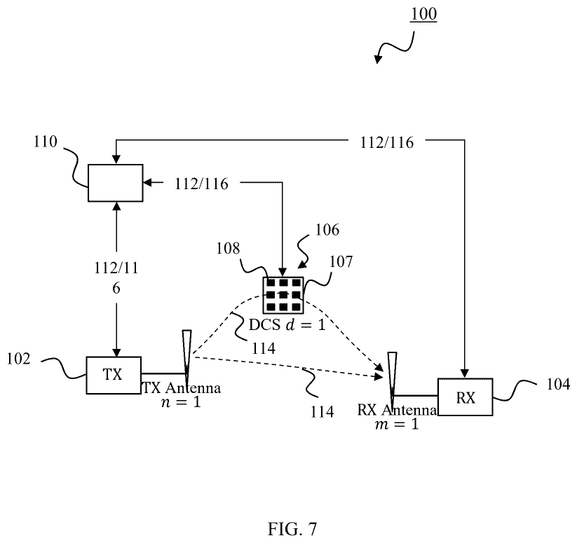

FIG. 7 shows a schematic diagram of another example of a wireless communication system 100, which builds on the exemplary embodiment shown in FIG. 4. Same elements are labelled with the same reference signs. In this example, the wireless communication system 100 may comprise the controller 110, one transmitter 102 with one transmitter antenna, one receiver 104 with one receiver antenna and a single DCS 106. The DCS 106 may comprise a scattering surface 107, and the scattering surface 107 may comprise a set of scattering elements 108.

The controller 110 may be configured to determine the STDC 112. That is, the controller 110 may be configured to determine the STDC matrix B. In this example, the total number of DCS is D=1 and it may be considered that Tₘₐₓ=2 and δ=2, which meets the requirement of δ≤D. The STDC matrix B may be based on the Alamouti STBC matrix in Equation (12) with values β₁=β₂=1 and ignoring the second column, given in Equation (30):

$$B = [ \begin{matrix}{β}_{1} \\ - {β}_{2}^{*}\end{matrix} ] = [ \begin{matrix}1 \\ - 1\end{matrix} ] . \qquad ( 30 )$$

Then, the controller 110 may be configured to send the total number T of the plurality of time slots 116 and the STDC matrix B by signaling to the transmitter 102, to the receiver 104 and to the DCS.

The controller 110 may be configured to determine the STDC matrix B offline, and may send the STDC matrix B, by signaling to the transmitter 102, to the receiver 104 and to the DCS 106 before the transmitter 102 transmits the coded radiofrequency signal to the receiver 104 during the plurality of time slots 116.

Alternatively, the controller 110, the transmitter 102, the receiver 104, additionally or alternatively the DCS 106 may be configured to store one or more tables comprising one or more STDC matrices B. Then, the controller 110 may be configured to send by signaling to the transmitter 102, to the receiver 104 and to the DCS 106, a code identifier. The code identifier may comprise information that specifies the STDC matrix B in Equation (30) of the one or more potential STDC matrices B stored in a lookup table to be used. The indication information may be implemented, for example, by an index that may specify that the STDC matrix B in Equation (30) of the one or more STDC matrices B in the table is to be used.

The controller 110 may be further configured to determine the base phase shift configuration matrix ϕ_{d} for the DCS 106, for example by any arbitrary, or random manner, or from a predefined list or using any available previous knowledge of the DCS 106 or a priori information about the propagation channels.

Then, the controller 110 may control, based on the STDC 112, the set of scattering elements 108 of the DCS d=1 106 during the T=2 time slots 116. That is, for each time slot 116 tᵢ∈{t₁, t₂} of the T=2 time slots, the controller 110 may be configured to determine the coded configuration for the DCS d=1 by setting a scattering pattern equal to B_{i,d} F_{d} (ϕ_{d})=α_{d} F_{d} (ϕ_{d}), with α_{d}=B_{i,d}, where B_{i,d} is the entry in the i-th row and d-th column of matrix B and F_{d} (ϕ_{d}) is the scattering pattern of the DCS d 106.

Since the first (and only) column of matrix B in Equation (30) is [β₁, −β*₂]^{T}=[1, −1]^{T}, then at the time slot t₁ the code for the DCS sets α₁=1, and the coded configuration for the DCS d=1 106 is equal to the scattering pattern F₁(ϕ₁). At the time slot t₂, it is obtained α₁=−1 and, thus, the coded configuration for the DCS is equal to −F₁ (ϕ₁). The scattering pattern via the DCS 106 and the propagation channel via the DCS 106 are as shown in Table 5, where

$${h}_{1} = {h}_{1 , 1 , 1} = {h}_{{DCS}_{1} \to RX}^{T} {F}_{1} ( {ϕ}_{1} ) {h}_{TX \to {DCS}_{1}} .$$

TABLE 5

| | Scattering Pattern | Channel via |
|---|---|---|
| | DCS 1 | DCS 1 |
| Time slot t₁ | β₁F₁(ϕ₁ = F₁(ϕ₁) | g₁ = β₁h₁ = h₁ |
| Time slot t₂ | −β₂*F₁(ϕ₁) = −F₁(ϕ₁) | g₁ = −β₂*h₁ = −h₁ |

Then, the controller 110 may be configured to control, based on the STDC 112, the transmitter 102 to generate a coded radiofrequency signal during the plurality of time slots 116. That is, for each time slot 116 t₁, t₂, the transmitter 102 may be configured to transmit an information symbol x in the coded radiofrequency signal, where the coded radiofrequency signal may comprise the transformation of the information symbol x based on the STDC matrix B, f_{TX} (x, B, tᵢ).

For the STDC matrix B specified in Equation (30), the transmitter 102 may be configured to send the information symbol x at the time slot 116 t₁, since the entries of the first row of the STDC matrix B is {β₁}∈{±β₁, ±β₂, 0}, and the transmitter 102 may be configured to send the x* at the time slot 116 t₂, since the second row of the STDC matrix B is {−β*₂}∈{±β*₁, ±β*₂, 0}).

The resulting one or more direct propagation channels and one or more propagation channels via the DCS 106 between the transmitter 102 and the receiver 104, as well as the transmitted and received signals for each time slot 116 are shown in Table 6.

TABLE 6

| | Transmitted | | Direct | Channel | |
|---|---|---|---|---|---|
| | symbol | α₁ | channel | via DCS 1 | Received signal |
| Training | p | 1 | h₀ | h₁ | yₚ_{₁} = (h₀ + h₁)p |
| time slot | | | | | |
| Training | p | −1 | h₀ | −h₁ | yₚ_{₂} = (h₀ − h₁)p |
| time slot | | | | | |
| Time slot | x | β₁ = 1 | h₀ | β₁h₁ = h₁ | yₜ_{₁} = (h₀ + h₁)x |
| t₁ | | | | | |
| Time slot | x* | −β₂* = −1 | h₀ | −β₂*h₁ = −h₁ | yₜ_{₂} = (h₀ − h₁)x* |
| t₂ | | | | | |

The transmitter 102 may send pilot symbols p using extra time slots. The transmitted pilots may be known at the receiver 104. The receiver 104 may use the transmitted pilots together with the received signals yₚ_{₁}, yₚ_{₂} and then may estimate the one or more channels via the DCS 106, h₁, additionally or alternatively the one or more direct channels h₀ as disclosed above in the previous examples. The estimated one or more channels 114 are scalars, thereby their estimation is easier compared to estimating channels whose size depends on the number of scattering elements 108 of the DCS 106, as it is the case in customary algorithms that use DCSs.

The received signal vector y after conjugation of the signal received by the receiver 104 in after the second time slot t₂ is given in Equation (31):

$$y = [ \begin{matrix}{y}_{{t}_{1}} \\ {y}_{{t}_{2}}^{*}\end{matrix} ] = [ \begin{matrix}{h}_{1} & {h}_{0} \\ {h}_{0}^{*} & - {h}_{1}^{*}\end{matrix} ] [ \begin{matrix}x \\ x\end{matrix} ] = H [ \begin{matrix}x \\ x\end{matrix} ] . \qquad ( 31 )$$

Then, a combining matrix Q can be easily computed as in Equation (32):

$$Q = {H}^{*} = [ \begin{matrix}{h}_{1}^{*} & {h}_{0} \\ {h}_{0}^{*} & - {h}_{1}\end{matrix} ] . \qquad ( 32 )$$

The matrix Q of Equation (32) can be applied to the received signal vector y, as shown in Equation (33):

$$Qy = [ \begin{matrix}{h}_{1}^{*} & 0 \\ {h}_{0}^{*} & - {h}_{1}\end{matrix} ] [ \begin{matrix}{h}_{1} & 0 \\ {h}_{0}^{*} & - {h}_{1}^{*}\end{matrix} ] [ \begin{matrix}x \\ x\end{matrix} ] = [ \begin{matrix}{\vert {h}_{1} \vert}^{2} + {\vert {h}_{0} \vert}^{2} & 0 \\ 0 & {\vert {h}_{1} \vert}^{2} + {\vert {h}_{0} \vert}^{2}\end{matrix} ] [ \begin{matrix}x \\ x\end{matrix} ] \qquad ( 33 )$$

which after being normalized, by multiplying all the terms by

$$\frac{1}{( {\vert {h}_{1} \vert}^{2} + {\vert {h}_{0} \vert}^{2} )} ,$$

gives two initial estimates \hat{x}_{init,1}, \hat{x}_{init,2} of the transmitted symbol x given in Equation (34):

$$[ \begin{matrix}{\hat{x}}_{init , 1} \\ {\hat{x}}_{init , 2}\end{matrix} ] = [ \begin{matrix}1 & 0 \\ 0 & 1\end{matrix} ] [ \begin{matrix}x \\ x\end{matrix} ] \qquad ( 34 )$$

that are averaged to obtain the final estimate of symbol x as in Equation (35):

$$\hat{x} = \frac{{\hat{x}}_{init , 1} + {\hat{x}}_{init , 2}}{2} = x . \qquad ( 35 )$$

Optionally, AWGN can be added to the received signal vector in Equation (31), which includes an additional noise term in the Equations above.

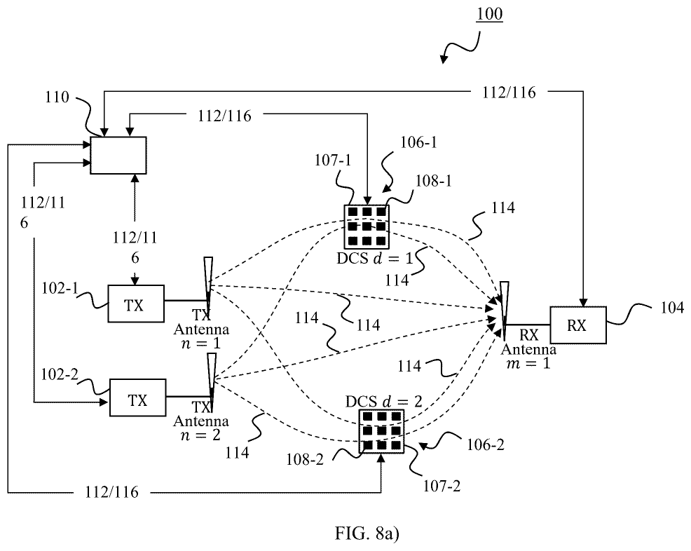

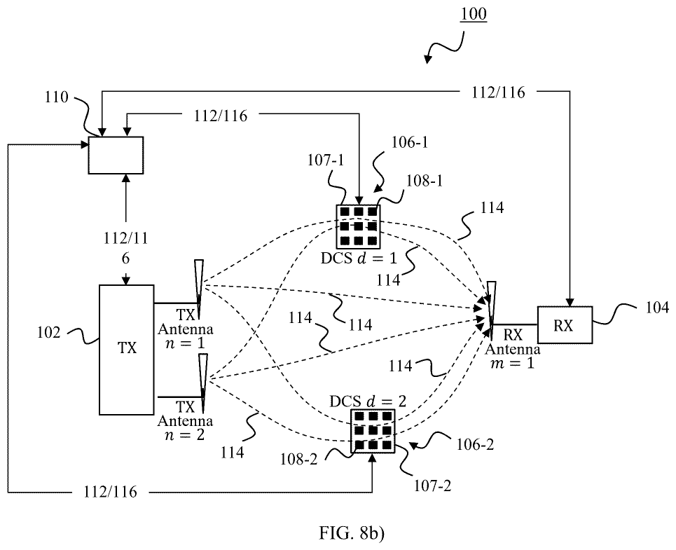

FIG. 8a) shows a schematic diagram of another example of a wireless communication system 100, which builds on the exemplary embodiment shown in FIG. 4. Same elements are labelled with the same reference signs. In this example, the wireless communication system 100 may comprise the controller 110, two transmitters 102-1, 102-2, two transmitter antennas i.e., n=1,2, each transmitter having a single transmitter antenna, one receiver 104 having a single receiver antenna i.e., m=1, and two DCSs d=1,2 106-1, 106-2. Each DCS 106-1, 106-2 may comprise a scattering surface 107-1, 107-2, and each scattering surface 107-1, 107-2 may comprise a set of scattering elements 108-1, 108-2.

The controller 110 may be configured to determine the STDC 112. That is, the controller 110 may be configured to determine the STDC matrix B. In this example, D=2 and it may be considered that Tₘₐₓ=2 and δ=2, which meets the requirement of δ≤D. The STDC matrix B may be chosen as the Alamouti STBC matrix given in Equation (12) above.

Then, the controller 110 may be configured to send the total number T of the plurality of time slots 116 and the STDC matrix B by signaling to the transmitters 102-1, 102-2, to the receiver 104 and to the DCSs 106-1, 106-2. Additionally or alternatively, the controller 110 may send by signaling to each DCS 106-1, 106-2 the respective d-th column of the STDC matrix B and the total number T of the plurality of time slots 116.

The controller 110 may be configured to determine the STDC matrix B offline, and may send the STDC matrix B, additionally or alternatively the d-th column of the STDC matrix B, by signaling to the transmitters 102-1, 102-2, to the receiver 104 and to the DCSs 106-1, 106-2 before each transmitter 102-1, 102-2 transmits a coded radiofrequency signal to the receiver 104 during the plurality of time slots 116.

Alternatively, the controller 110, the transmitters 102-1, 102-2, the receiver 104, additionally or alternatively the DCSs 106-1, 106-2 may be configured to store one or more tables comprising one or more STDC matrices B. Then, the controller 110 may be configured to send by signaling to the transmitters 102-1, 102-2, to the receiver 104 and to the DCSs 106-1, 106-2, a code identifier. The code identifier may comprise information that specifies the STDC matrix B provided in Equation (12) of the one or more STDC matrices B stored in a lookup table to be used. The indication information may be implemented, for example, by an index that may specify the STDC matrix B provided in Equation (12) of the one or more STDC matrices B in the table to be used.

The controller 110 may be further configured to determine the base phase shift configuration matrix ϕ_{d} for each DCS d 102-1, 102-2, for example in an arbitrary, or random manner, or from a predefined list or using any available previous knowledge of the DCSs 106-1, 106-2.

Then, the controller 110 may control, based on the STDC 112, the set of scattering elements 108-1, 108-2 of the DCS 106-1, 106-2 during the T=2 time slots 116, as disclosed above in the example of FIG. 6. The details are not repeated again.

The coded configuration for each DCS 106-1, 106-2 is independent of the number of transmitters 102-1, 102-2 and transmitter antennas and is also independent of the information symbols sent by the transmitters 102-1, 102-2. The coded configuration for each time slot 116 and for each DCS 106-1, 106-2 is the same as for the example of FIG. 6 and is shown in Table 1 above.

In this example, since there are two single antenna transmitters 102-1, 102-2 and two DCSs 106-1, 106-2, there may be a total of four propagation channels via the DCSs 106-1, 106-2 given in Equations (36) to (43):

$${h}_{1} = {h}_{1 , 1 , 1} = {h}_{{DCS}_{1} \to RX}^{T} {F}_{1} ( {ϕ}_{1} ) {h}_{{TX}_{1} \to {DCS}_{1}} \qquad ( 36 )$$

$${h}_{2} = {h}_{1 , 2 , 1} = {h}_{{DCS}_{2} \to RX}^{T} {F}_{2} ( {ϕ}_{2} ) {h}_{{TX}_{1} \to {DCS}_{2}} \qquad ( 37 )$$

$${h}_{3} = {h}_{1 , 1 , 2} = {h}_{{DCS}_{1} \to RX}^{T} {F}_{1} ( {ϕ}_{1} ) {h}_{{TX}_{2} \to {DCS}_{1}} \qquad ( 38 )$$

$${h}_{4} = {h}_{1 , 2 , 2} = {h}_{{DCS}_{2} \to RX}^{T} {F}_{2} ( {ϕ}_{2} ) {h}_{{TX}_{2} \to {DCS}_{2}} \qquad ( 39 )$$

$$and$$

$${g}_{1} = {g}_{1 , 1 , 1} = {α}_{1} {h}_{1 , 1 , 1} = {α}_{1} {h}_{1} \qquad ( 40 )$$

$${g}_{2} = {g}_{1 , 2 , 1} = {α}_{1} {h}_{1 , 2 , 1} = {α}_{1} {h}_{2} \qquad ( 41 )$$

$${g}_{3} = {g}_{1 , 1 , 2} = {α}_{1} {h}_{1 , 1 , 2} = {α}_{3} {h}_{3} \qquad ( 42 )$$

$${g}_{4} = {g}_{1 , 2 , 2} = {α}_{1} {h}_{1 , 2 , 2} = {α}_{4} {h}_{4} \qquad ( 43 )$$

where Equation (3) has been used for obtaining g₁, g₂, g₃, g₄, which defines that for a DCS d 106-1, 106-2 with coded configuration equal to α_{d} F_{d} (ϕ_{d}), the resulting channel via the DCS d from a transmitter antenna n of one of transmitters 102-1 and 102-2, to the receiver antenna m of receiver 104 is g_{m,d,n}=α_{d}h_{m,d,n}.

The one or more propagation channels from the transmitters 102-1, 102-2 via the DCSs 102-1, 102-2 for each time slot 116 are shown in Table 7.

TABLE 7

| | Channel from | Channel from | Channel from | Channel from |
|---|---|---|---|---|
| | TX 1 via DCS 1 | TX 1 via DCS 2 | TX 2 via DCS 1 | TX 2 via DCS 2 |
| | g₁ | g₂ | g₃ | g₄ |
| Time slot t₁ | β₁h₁ | β₂h₂ | β₁h₃ | β₂h₄ |
| Time slot t₂ | −β₂*h₁ | β₁*h₂ | −β₂*h₃ | β₁*h₄ |

As can be seen from Table 7, the propagation channels g₁, g₂, g₃, g₄ change as a function of the values of the STDC matrix B given in Equation (12), thus providing channel programming with the STDC 112.

Then, the controller 110 may be configured to control, based on the STDC 112, each transmitter 102-1, 102-2 to generate a coded radiofrequency signal during the plurality of time slots 116. That is, for each time slot 116 tᵢ, each transmitter 102-1, 102-2 may be configured to transmit an information symbol x in the coded radiofrequency signal, where the coded radiofrequency signal may comprise a transformation of the information symbol x based on the STDC matrix B, denoted as f_{TX} (x, B, tᵢ).

The information symbol transmitted from each transmitter 102-1, 102-2 is denoted as xₙ, with n=1, 2. The two symbols x₁ and x₂ can be completely independent. Each transmitter 102-1, 102-2 may transmit the same information symbol xₙ in the coded radiofrequency signal during the two time slots 116 t₁ and t₂.

Using the STDC matrix B specified in Equation (12), for the time slot t₁, the transmitter antenna n of transmitter 102-n may be configured to send the symbol xₙ since the entries of the first row of the STDC matrix B are {β₁, β₂}∈{±β₁, ±β₂, 0}. For time slot t₂, the transmitter antenna n of transmitter 102-n may be configured to send the symbol x*ₙ at time slot t₂, since the entries of the second row of the STDC matrix B are {β*₁, −β*₂}∈{±β*₁, ±β*₂0}. The symbol transmitted by the transmitters 102-1, 102-2 for each time slot 116 is summarized in Table 8.

TABLE 8

| | Transmitted symbol | Transmitted symbol |
|---|---|---|
| | from TX n = 1 | from TX n = 2 |
| Time slot t₁ | x₁ | x₂ |
| Time slot t₂ | x₁* | x₂* |

In the example of FIG. 8a), the transmitters 102-1, 102-2 may be further configured, based on the STDC 112, to transmit training pilots p during additional or training time slots. Said training pilots p transmitted during the training time slots may be needed for the receiver 104 in order to estimate the one or more propagation channels 114, in case that the estimates of the one or more propagation channels via the at least one DCS and/or one or more direct propagation channels are not yet available at the receiver 104.

Table 9 shows the coded radiofrequency signal transmitted by the transmitters 102-1, 102-2 including the extra time slots for transmission of training pilots p, for the two time slots 116 t₁, t₂. The value of ad for each DCS 106-1, 106-2 is also shown in Table 9. During the two time slots t₁ and t₂, the value of da depends on the STDC matrix B. During the training time slots, the controller 110 may be configured to control the set of scattering elements 108-1, 108-2 of the DCSs 106-1, 106-2 by setting values of aa, for example, in a predetermined manner. The resulting direct propagation channels between the transmitters 102-1, 102-2 and the receiver 104 denoted as h_{0,1}, h_{0,2}, and the propagation channels via the two DCSs 106-1 106-2 are also shown in Table 9.

TABLE 9

| | Transmitted | | | | | | | | |
|---|---|---|---|---|---|---|---|---|---|
| | symbol | | | | DCS channels | | | | |
| | TX 1 | TX 2 | α₁ | α₂ | g₁ | g₂ | g₃ | g₄ | Received signal |
| Training | p | 0 | 1 | 1 | h₁ | h₂ | h₃ | h₄ | yₚ_{₁} = |
| time slot | | | | | | | | | (h_{0, 1} + h₁ + h₂)p |
| Training | p | 0 | 1 | −1 | h₁ | −h₂ | h₃ | −h₄ | yₚ_{₂} = |
| time slot | | | | | | | | | (h_{0, 1} + h₁ − h₂)p |
| Training | p | 0 | −1 | −1 | −h₁ | −h₂ | −h₃ | −h₄ | yₚ_{₃} = |
| time slot | | | | | | | | | (h_{0, 1} − h₁ − h₂)p |
| Training | 0 | p | 1 | 1 | h₁ | h₂ | h₃ | h₄ | yₚ_{₄} = |
| time slot | | | | | | | | | (h_{0, 2} + h₃ + h₄)p |
| Training | 0 | p | 1 | −1 | h₁ | −h₂ | h₃ | −h₄ | yₚ_{₅} = |
| time slot | | | | | | | | | (h_{0, 2} + h₃ − h₄)p |
| Training | 0 | p | −1 | −1 | −h₁ | −h₂ | −h₃ | −h₄ | yₚ_{₆} = |
| time slot | | | | | | | | | (h_{0, 2} − h₃ − h₄)p |
| Time | x₁ | x₂ | β₁ | β₂ | β₁h₁ | β₂h₂ | β₁h₃ | β₂h₄ | yₜ_{₁} = |
| slot t₁ | | | | | | | | | (h_{0, 1} + β₁h₁ + |
| | | | | | | | | | β₂h₂)x₁ + |
| | | | | | | | | | (h_{0, 2} + β₁h₃ + |
| | | | | | | | | | β₂h₄ )x₂ |
| Time | x₁* | x₂* | −β₂* | β₁* | −β₂*h₁ | β₁*h₂ | −β₂*h₃ | β₁*h₄ | yₜ_{₂} = |
| slot t₂ | | | | | | | | | (h_{0, 1} − β₂*h₁ + |
| | | | | | | | | | β₁*h₂)x₁* + |
| | | | | | | | | | (h_{0, 2} − β₂*h₃ + |
| | | | | | | | | | β₁*h₄)x₂* |

The transmitted pilots p may be known at the receiver 104. Then, for each training time slot, the receiver 104 may be configured to estimate the one or propagation channels via the DCS 106-1, 106-2, h₁, h₂, h₃, h₄, additionally or alternatively the one or more direct propagation channels h_{0,1}, h_{0,2} based on the received training pilots p and on the received signals yₚ_{₁}, yₚ_{₂}, yₚ_{₃}, yₚ_{₄}, yₚ_{₅} and yₚ_{₆}. The propagation channels 114 are scalars, and their estimation is easier compared to estimating channels whose size depends on the number of scattering elements 108-1, 108-2 of each DCS 106-1 106-2, as in customary algorithms that use DCSs.

Further, for each time slot 116 t₁, t₂, the receiver 104 may be configured to determine the information symbols xₙ transmitted by one of the transmitters 102-1, 102-2 based on the STDC 112, based on the received coded radiofrequency signals, and based on the estimated one or more propagation channels via the DCSs 106-1, 106-2, additionally or alternatively the estimated one or more direct propagation channels.

To that end, the receiver 104 may proceed as follows. The received signal vector y is constructed by stacking the signal received at the first time slot, namely yₜ_{₁} and using the conjugate of the signal received at the second time slot, namely

$${y}_{{t}_{2}}^{*} .$$

The signal received in the second time slot is conjugated because the information symbols transmitted in the second time slot were sent as the conjugates x*₁ and x*₂. Following this approach, the received signal vector y may take the form of Equation (44):

$$y = [ \begin{matrix}{y}_{{t}_{1}} \\ {y}_{{t}_{2}}^{*}\end{matrix} ] = [ \begin{matrix}{h}_{1} & {h}_{2} & {h}_{0 , 1} & {h}_{3} & {h}_{4} & {h}_{0 , 2} \\ {h}_{2}^{*} & - {h}_{1}^{*} & {h}_{0 , 1}^{*} & {h}_{4}^{*} & - {h}_{3}^{*} & {h}_{0 , 2}^{*}\end{matrix} ] \qquad ( 44 )$$

Since h_{0,1}, h_{0,2}, h₁, h₂, h₃ and h₄ have been estimated by the receiver 104, the overall channel matrix H can be constructed as in Equation (45):

$$H = [ \begin{matrix}{h}_{1} & {h}_{2} & {h}_{0 , 1} & {h}_{3} & {h}_{4} & {h}_{0 , 2} \\ {h}_{2}^{*} & - {h}_{1}^{*} & {h}_{0 , 1}^{*} & {h}_{4}^{*} & - {h}_{3}^{*} & {h}_{0 , 2}^{*}\end{matrix} ] \qquad ( 45 )$$

The channel matrix of Equation (45) can be used to write the received signal vector as Equation (46):

$$y = {H [ {β}_{1} {x}_{1} , {β}_{2} {x}_{1} , {x}_{1} , {β}_{1} {x}_{2} , {β}_{2} {x}_{2} , {x}_{2} ]}^{T} \qquad ( 46 )$$

A combining matrix Q and a normalizing matrix N can be computed as shown in Equation (47) and Equation (48) respectively,

$$Q = {H}^{*} \qquad ( 47 )$$

$$N = diag ( \frac{1}{{β}_{1} ( {\vert {h}_{1} \vert}^{2} + {\vert {h}_{2} \vert}^{2} )} , \frac{1}{{β}_{2} ( {\vert {h}_{1} \vert}^{2} + {\vert {h}_{2} \vert}^{2} )} , \frac{1}{2 {\vert {h}_{0 , 1} \vert}^{2}} , \frac{1}{{β}_{1} ( {\vert {h}_{3} \vert}^{2} + {\vert {h}_{4} \vert}^{2} )} , \frac{1}{{β}_{2} ( {\vert {h}_{3} \vert}^{2} + {\vert {h}_{4} \vert}^{2} )} , \frac{1}{2 {\vert {h}_{0 , 2} \vert}^{2}} ) \qquad ( 48 )$$

where H* is used to denote the transpose conjugate of H. Using the received signal vector y in Equation (44), the combining matrix Q in Equation (47) and the normalizing matrix N in Equation (48), three initial estimates [symbol] _{init,1}, [symbol] _{init,2}, [symbol] _{init,3} of the transmitted symbol x₁ and three initial estimates [symbol] _{init,1}, [symbol] _{init,2}, [symbol] _{init,3} of the transmitted symbol x₂ can be obtained as in Equation (49):

$$[ \begin{matrix}{init , 1}_{} \\ {init , 2}_{} \\ {init , 3}_{} \\ {init , 1}_{} \\ {init , 2}_{} \\ {init , 3}_{}\end{matrix} ] = NQy . \qquad ( 49 )$$

The three initial estimates [symbol] _{init,1}, [symbol] _{init,2}, [symbol] _{init,3} can be combined to obtain the final estimate of x₁ given in Equation (50):

$$\begin{matrix}= \frac{1}{3} {\sum }_{i = 1}^{3} {init , i}_{} \\ = {x}_{1} + {z}_{1}\end{matrix} \qquad ( 50 )$$

Similarly, the three initial estimates [symbol] _{init,1}, [symbol] _{init,2}, [symbol] _{init,3} can be combined to obtain the final estimate of x₂ given in Equation (51):

$$\begin{matrix}= \frac{1}{3} {\sum }_{i = 1}^{3} {init , i}_{} \\ = {x}_{2} + {z}_{2}\end{matrix} \qquad ( 51 )$$

Since the propagation channels h_{0,1}, h_{0,2}, h₁, h₂, h₃ and h₄ are independent random variables, the resulting noise terms z₁ and z₂ in Equations (50) and (51) are expected to be Gaussian random variables with zero mean distribution, z₁˜ [symbol] (0, v_{z}_{₁}) and z₂˜ [symbol] (0, v_{z}_{₂}). It is expected that as the number of at least one transmitters in the wireless communication system 100 increases, the variance of these noise terms decreases and the values of z₁ and z₂ get very close to their mean, i.e., very close to zero. This may provide further advantages when the wireless communication system 100 may comprise multiple low complexity transmitters, for example multiple independent IoT devices.

Adaptation to multiple antenna transmitters is straightforward following the example of FIG. 8a) with two transmitters, as depicted in FIG. 8b). FIG. 8b) shows an example of a wireless communication system 100, which builds on the exemplary embodiment shown in FIG. 4, for a case with a single transmitter 102 with two transmitter antennas. Same elements are labelled with the same reference signs. Following the example of FIG. 8a), the same propagation channels as in Table 7 are obtained, the same transmitted symbols per antenna as in Table 8 and Table 9 are obtained, and same received signals as in Table 9 are obtained. The signal processing at the receiver 104 is the same as described in relation to Equation (44) to Equation (51).

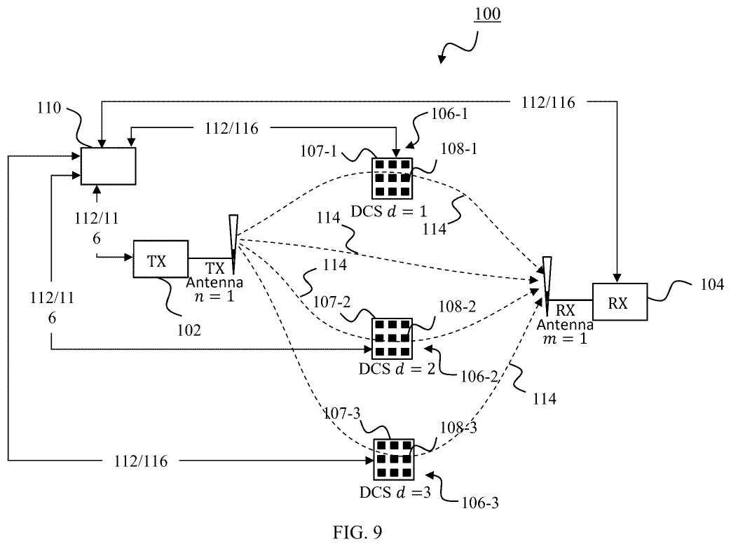

Extension to more than two transmitters is straightforward following the examples of FIG. 8a) with two transmitters 102-1 102-2 and FIG. 8b) with multiple antenna transmitter. FIG. 9 shows a schematic diagram of a further example of a wireless communication system 100, which builds on the exemplary embodiment shown in FIG. 4. Same elements are labelled with the same reference signs. In this example, the wireless communication system 100 may comprise the controller 110, a transmitter 102, with a single transmitter antenna n=1, a receiver 104, with a single receiver antenna i.e., m=1, and three DCSs 106-1, 106-2, 106-3, i.e., d=1, 2, 3. Each DCS 106-1, 106-2, 106-3 may comprise a scattering surface 107-1, 107-2, 107-3, and each scattering surface 107-1, 107-2, 107-3 may comprise a set of scattering elements 108-1, 108-2, 108-3.

The controller 110 may be configured to determine the STDC 112. That is, the controller 110 may be configured to determine the STDC matrix B. In this example, D=3 and it may be considered that Tₘₐₓ=4 and δ=3, which meets the requirement of δ≤D. A STBC matrix that maps three complex values {β₁, β₂, β_{67 =3}} onto a T×D matrix B such that T≤Tₘₐₓ is given in Equation (52):

$$B = [ \begin{matrix}{β}_{1} & {β}_{2} & {β}_{3} \\ - {β}_{2}^{*} & {β}_{1}^{*} & 0 \\ {β}_{3}^{*} & 0 & - {β}_{1}^{*} \\ 0 & {β}_{3}^{*} & - {β}_{2}^{*}\end{matrix} ] . \qquad ( 52 )$$

The matrix B given in Equation (52) meets the constraint that the entries of a given row belong to either to {±β₁, ±β₂, ±β₃, 0} or to {±β*₁, β*₂, ±β*₃, 0} but not to both. This is easily verifiable by inspection. The quantities β₁, β₂, and β₃ are kept generally as scalar complex values.

Further, the controller 110 may be configured to send the total number T of the plurality of time slots 116 and the STDC matrix B by signaling to the transmitter 102, to the receiver 104 and to the DCSs 106-1, 106-2, 106-3. Alternatively, instead of the full STDC matrix B, the controller 110 may send by signaling to each DCSs 106-1, 106-2, 106-3 the respective d-th column of the STDC matrix B and the total number T of the plurality of time slots 116.

The controller 110 may be configured to determine the STDC matrix B offline, and may send the STDC matrix B in Equation (52), additionally or alternatively the d-th column of the STDC matrix B, by signaling to the transmitter 102, to the receiver 104 and to the DCSs 106-1, 106-2, 106-3 before the transmitter 102 transmits the coded radiofrequency signal to the receiver 104 during the plurality of time slots 116.

Alternatively, the controller 110, the transmitter 102, the receiver 104, additionally or alternatively DCSs 106-1, 106-2, 106-3 may be configured to store one or more tables comprising one or more STDC matrices B. Then, the controller 110 may be configured to send by signaling to the transmitter 102, to the receiver 104 and to the DCSs 106-1, 106-2, 106-3, a code identifier. The code identifier may comprise information that specifies the STDC matrix B in Equation (52) of the one or more STDC matrices B stored in a lookup table to be used. The indication information may be implemented, for example, by an index that may specify the STDC matrix B in Equation (52) of the one or more STDC matrices B in the table to be used.

The controller 110 may be further configured to determine the base phase shift configuration matrices ϕ₁, ϕ₂, ϕ₃ for each DCS 106-1, 106-2, 106-3. The base phase shift configuration matrices ϕ₁, ϕ₂, ϕ₃ may be obtained by the controller 110 via any arbitrary, or random manner or from a predefined list or using any available previous knowledge of the DCSs 106-1, 106-2, 106-3.

Then, the controller 110 may control, based on the STDC 112, the set of scattering elements 108-1, 108-2, 108-3 of the DCSs 106-1, 106-2, 106-3 during the T=4 time slots 116. That is, for each time slot 116 tᵢ∈{t₁, t₂, t₃, t₄}, the controller 110 may be configured to determine the coded configuration for the DCS d, with d=1, 2, 3, by setting a scattering pattern equal to B_{i,d}F_{d}(ϕ_{d})=α_{d}F_{d}(ϕ_{d}), with α_{d}=B_{i,d}, where B_{i,d} is the entry in the i-th row and d-th column of matrix B as disclosed above, and F_{d}(ϕ_{d}) is the scattering pattern of each DCS d 106-1, 106-2, 106-3.

The resulting coded configuration for each time slot 116 and for each DCS 106-1, 106-2, 106-3 is shown in Table 10.

TABLE 10

| | Scattering Pattern | Scattering Pattern | Scattering Pattern |
|---|---|---|---|
| | DCS 1 | DCS 2 | DCS 3 |
| | α₁F₁(ϕ₁) | α₂F₂(ϕ₂) | α₃F₃(ϕ₃) |
| Time slot t₁ | β₁F₁(ϕ₁) | β₂F₂(ϕ₂) | β₃F₃(ϕ₃) |
| Time slot t₂ | −β₂*F₁(ϕ₁) | β₁*F₂(ϕ₂) | 0 |
| Time slot t₃ | β₃*F₁(ϕ₁) | 0 | −β₁*F₃(ϕ₃) |
| Time slot t₄ | 0 | β₃*F₂(ϕ₂) | −β₂*F₃(ϕ₃) |

A scattering pattern equal to zero (0) may be obtained by using a DCS surface whose scattering properties can be turned off, or using a specific DCS configuration such that the energy scattered by the scattering elements is minimized, this is known for example in the context of radars as minimizing radar cross section.

In this example with a single antenna transmitter 102 and a single antenna receiver 104, hence n=1 and m=1, the one or more propagation channels via the DCSs 106-1, 106-2, 106-3 denoted as h₁=h_{1,1,1}, h₂=h_{1,2,1} and h₃=h_{1,3,1} are based on Equation (1) and are given by Equations (53) to (55):

$${h}_{1} = {h}_{1 , 1 , 1} = {h}_{{DCS}_{1} \to {RX}_{1}}^{T} {F}_{1} ( {ϕ}_{1} ) {h}_{{TX}_{1} \to {DCS}_{1}} \qquad ( 53 )$$

$${h}_{2} = {h}_{1 , 2 , 1} = {h}_{{DCS}_{2} \to {RX}_{1}}^{T} {F}_{2} ( {ϕ}_{2} ) {h}_{{TX}_{1} \to {DCS}_{2}} \qquad ( 54 )$$

$${h}_{3} = {h}_{1 , 3 , 1} = {h}_{{DCS}_{3} \to {RX}_{1}}^{T} {F}_{3} ( {ϕ}_{3} ) {h}_{{TX}_{1} \to {DCS}_{3}} \qquad ( 55 )$$

Using Equation (3), which defines that for a DCS d with scattering pattern equal to α_{d} F_{d} (ϕ_{d}), the resulting propagation channel via the DCS d from the transmitter antenna n=1 to the receiver antenna m=1 is g_{1,d,1}=α_{d}h_{1,d,1}. Further, for brevity of notation, it is defined g₁=g_{1,1,1}=α₁h_{1,1,1}=α₁h₁, g₂=g_{1,2,1}=α₂h_{1,2,1}=α₂h₂ and g₃=g_{1,3,1}=α₃h_{1,3,1}=α₃h₃. The propagation channels via each DCS 106-1, 106-2, 106-3 are shown in Table 11.

TABLE 11

| | Channel via | Channel via | Channel via |
|---|---|---|---|
| | DCS 1 | DCS 2 | DCS 3 |
| | g₁ = α₁h₁ | g₂ = α₂h₂ | g₃ = α₃h₃ |
| Time slot t₁ | β₁h₁ | β₂h₂ | β₃h₃ |
| Time slot t₂ | −β₂*h₁ | β₁*h₂ | 0 |
| Time slot t₃ | β₃*h₁ | 0 | −β₁*h₃ |
| Time slot t₄ | 0 | β₃*h₂ | −β₂*h₃ |

The controller 110 may be configured to control, based on the STDC 112, the transmitter 102 to generate the coded radiofrequency signal. That is, for each time slot 116 tᵢ, the transmitter 102 may be configured to transmit an information symbol x in the coded radiofrequency signal. The coded radiofrequency signal may comprise a transformation of the information symbol x based on the STDC matrix B given in Equation (52), denoted as f_{TX} (x, B, tᵢ).

For the time slot tᵢ, if the entries of the i-th row of the STDC matrix B belong to {±β₁, ±β₂, ±β₃, 0}, then the transmitter 102 may be configured to send the symbol x, otherwise, if the entries of the i-th row of the STDC matrix B belong to {±β*₁, ±β*₂, ±β*₃, 0}, then the transmitter 102 may be configured to send the symbol x*. Consequently, based on the STDC matrix B given in Equation (52) for this example, the symbol transmitted by the transmitter for each time slot 116 is shown in Table 12.

TABLE 12

| | Transmitted |
|---|---|
| | symbol |
| Time slot t₁ | x |
| Time slot t₂ | x* |
| Time slot t₃ | x* |
| Time slot t₄ | x* |

In the example of FIG. 9, the transmitter 102 may be further configured to transmit training pilots p during additional or training time slots. Said training pilots p transmitted during the additional or training time slots may be needed for the receiver 104 to estimate the one or more propagation channels 114, in case that the estimates of the one or more propagation channels via the at least one DCS and/or one or more direct propagation channels are not yet available at the receiver 104.

Table 13 shows the coded signal transmitted by the transmitter 102 including the training time slots for transmission of training pilots p for channel estimation and including the signal transmitted during the four time slots 116 t₁, t₂, t₃, t₄. The value of α_{d} for each DCS 106-1, 106-2, 106-3 is also shown in Table 13. As explained above, during the four time slots 116 t₁, t₂, t₃, t₄, α_{d} depends on the values of the STDC matrix B. During the training time slots 116, the controller 110 may be configured to control the set of scattering elements 108-1, 108-2, 108-3 of the DCS 106-1, 106-2, 106-3 by setting values of α_{d}, for example, in a predetermined manner based on the STDC matrix B. The resulting direct propagation channels between the transmitter 102 and the receiver 104, the propagation channels via the DCSs 106-1, 106-2, 106-3 as well as the coded radiofrequency signal received by the receiver 104 for each time slot 116 as well as the training slots are also included in Table 13.

TABLE 13

| | | | | | | Channel | Channel | Channel | |
|---|---|---|---|---|---|---|---|---|---|
| | Transmitted | | | | Direct | via DCS 1 | via DCS 2 | via DCS 3 | |
| | symbol | α1 | α2 | α2 | channel | g₁ | g₂ | g₃ | Received signal |
| Training | p | 1 | 1 | 1 | h₀ | h₁ | h₂ | h₃ | yₚ_{₁} = |
| time slot | | | | | | | | | (h₀ + h₁ + h₂ + h₂)p |
| Training | p | −1 | 1 | 1 | h₀ | −h₁ | h₂ | h₃ | yₚ_{₂} = |
| time slot | | | | | | | | | (h₀ − h₁ + h₂ + h₃)p |
| Training | p | 1 | −1 | 1 | h₀ | h₁ | −h₂ | h₃ | yₚ_{₃} = |
| time slot | | | | | | | | | (h₀ + h₁ − h₂ + h₃)p |
| Training | p | 1 | 1 | −1 | h₀ | h₁ | h₂ | −h₃ | yₚ_{₄} = |
| time slot | | | | | | | | | (h₀ + h₁ + h₂ − h₃)p |
| Time | x | β₁ | β₂ | β₃ | h₀ | β₁h₁ | β₂h₂ | β₃h₃ | yₜ_{₁} = |
| slot t₁ | | | | | | | | | (h₀ + β₁h₁ + |
| | | | | | | | | | β₂h₂ + β₃h₃)x |
| Time | x* | −β₂* | β₁* | 0 | h₀ | −β₂*h₁ | β₁*h₂ | 0 | yₜ_{₂} = |
| slot t₂ | | | | | | | | | (h₀ − β₂*h₁ + β₁*h₂)x* |
| Time | x* | β₃* | 0 | −β₁* | h₀ | β₃*h₁ | 0 | −β₁*h₃ | yₜ_{₃} = |
| slot t₃ | | | | | | | | | (h₀ + β₃*h₁ − β₁*h₃)x* |
| Time | x* | 0 | β₃* | −β₂* | h₀ | 0 | β₃*h₂ | −β₂*h₃ | yₜ_{₄} = |
| slot t₃ | | | | | | | | | (h₀ + β₃*h₂ − β₂*h₃)x* |

The transmitted pilots p may be known at the receiver 104. Then, for each training time slot the receiver 104 may be configured to estimate the one or more propagation channels via the DCS 106-1, 106-2, 106-3 h₁, h₂, h₃, additionally or alternatively to estimate the one or more direct propagation channels h₀, based on the received training pilots p and on the received signals yₚ_{₁}, yₚ_{₂}, yₚ_{₃} and yₚ_{₄}. These channels are just scalars, so their estimation is easier compared to estimating channels whose size depends on the number of scattering elements 108-1, 108-2, 108-3 of each DCS 106-1, 106-2, 106-3, as in customary algorithms that use DCSs.

Further, the receiver 104 may be configured to determine the information symbol x transmitted by the transmitter 102 based on the STDC 112, based on the received coded radiofrequency signal during the time slots 116, and based on the estimated one or more propagation channels via the DCSs 106-1, 106-2, 106-3, additionally or alternatively the estimated one or more direct propagation channels.

To that end, the receiver 104 may proceed as follows. The decoding of the chosen 4×3 STDC matrix B given in Equation (52) involves using the signal received at the first time slot of the plurality of timeslots 116, namely yₜ_{₁}, and also using the conjugate of the signal received at the following time slots, namely

$${y}_{{t}_{2}}^{*} , {y}_{{t}_{3}}^{*} and {y}_{{t}_{4}}^{*} .$$

Following this approach, the received signal vector y may be written as Equation (56):

$$y = [ \begin{matrix}{y}_{{t}_{1}} \\ {y}_{{t}_{2}}^{*} \\ {y}_{{t}_{3}}^{*} \\ {y}_{4}^{*}\end{matrix} ] = [ \begin{matrix}( {β}_{1} {h}_{1} + {β}_{2} {h}_{2} + {β}_{3} {h}_{3} + {h}_{0} ) x \\ ( - {β}_{2} {h}_{1}^{*} + {β}_{1} {h}_{2}^{*} + 0 {h}_{3}^{*} + {h}_{0}^{*} ) x \\ ( {β}_{3} {h}_{1}^{*} + 0 {h}_{2}^{*} - {β}_{1} {h}_{3}^{*} + {h}_{0}^{*} ) x \\ ( 0 {h}_{1}^{*} + {β}_{3} {h}_{2}^{*} - {β}_{2} {h}_{3}^{*} + {h}_{0}^{*} ) x\end{matrix} ] = [ \begin{matrix}{h}_{1} & {h}_{2} & {h}_{3} & {h}_{0} \\ {h}_{2}^{*} & - {h}_{1}^{*} & 0 & {h}_{0}^{*} \\ - {h}_{3}^{*} & 0 & {h}_{1}^{*} & {h}_{0}^{*} \\ 0 & - {h}_{3}^{*} & {h}_{2}^{*} & {h}_{0}^{*}\end{matrix} ] [ \begin{matrix}{β}_{1} x \\ {β}_{2} x \\ {β}_{3} x \\ x\end{matrix} ] . \qquad ( 56 )$$

Since the one or more propagation channels h₀, h₁ and h₂ have been estimated by the receiver 104, the overall channel matrix H can be constructed as in Equation (57):

$$H = [ \begin{matrix}{h}_{1} & {h}_{2} & {h}_{3} & {h}_{0} \\ {h}_{2}^{*} & - {h}_{1}^{*} & 0 & {h}_{0}^{*} \\ - {h}_{3}^{*} & 0 & {h}_{1}^{*} & {h}_{0}^{*} \\ 0 & - {h}_{3}^{*} & {h}_{2}^{*} & {h}_{0}^{*}\end{matrix} ] . \qquad ( 57 )$$

The channel matrix H of Equation (57) can be used to write a received signal vector as in Equation (58):

$$y = H [ \begin{matrix}{β}_{1} x \\ {β}_{2} x \\ {β}_{3} x \\ x\end{matrix} ] . \qquad ( 58 )$$

A combining matrix Q and normalizing matrix N can be easily computed as shown in Equation (59) and Equation (60) respectively:

$$Q = {H}^{*} = [ \begin{matrix}{h}_{1}^{*} & {h}_{2} & - {h}_{3} & 0 \\ {h}_{2}^{*} & - {h}_{1} & 0 & - {h}_{3} \\ {h}_{3}^{*} & 0 & {h}_{1} & {h}_{2} \\ {h}_{0}^{*} & {h}_{0} & {h}_{0} & {h}_{0}\end{matrix} ] \qquad ( 59 )$$

$$N = diag ( \frac{1}{{β}_{1} ( {\vert {h}_{1} \vert}^{2} + {\vert {h}_{2} \vert}^{2} + {\vert {h}_{3} \vert}^{2} )} , \\ \frac{1}{{β}_{2} ( {\vert {h}_{1} \vert}^{2} + {\vert {h}_{2} \vert}^{2} + {\vert {h}_{3} \vert}^{2} )} , \frac{1}{{β}_{3} ( {\vert {h}_{1} \vert}^{2} + {\vert {h}_{2} \vert}^{2} + {\vert {h}_{3} \vert}^{2} )} , \frac{1}{4 {\vert {h}_{0} \vert}^{2}} ) . \qquad ( 60 )$$

Using the received signal vector y in Equation (58), the combining matrix Q in Equation (59), and the normalizing matrix N in Equation (60), four initial estimates \hat{x}_{init,1}, \hat{x}_{init,2}, \hat{x}_{init,3}, \hat{x}_{init,4} of the transmitted symbol x can be obtained as given in Equation (61):

$$[ \begin{matrix}{\hat{x}}_{init , 1} \\ {\hat{x}}_{init , 2} \\ {\hat{x}}_{init , 3} \\ {\hat{x}}_{init , 4}\end{matrix} ] = NQy . \qquad ( 61 )$$

The four initial estimates \hat{x}_{init,1}, \hat{x}_{init,2}, \hat{x}_{init,3}, \hat{x}_{init,4} can be combined to obtain the final estimate of the transmitted symbol x as in Equation (62):

$$\hat{x} = \frac{1}{4} {\sum }_{i = 4} {\hat{x}}_{init , i} = x + zx . \qquad ( 62 )$$

The noise term zx depends both on the symbol x and the scaling term z. Since the channels h₀, h₁, h₂ and h₃ are independent and random, the resulting expression for z is expected to result in a random variable with zero mean distribution as z˜ [symbol] (0, v_{z}), where [symbol] (0, v_{z}) is a Gaussian distribution with mean zero and variance v_{z}, which will depend on the channel statistics and the combination of terms in that result in the term z. It is mentioned that using more DCSs, the term z includes extra random terms adding; hence, the variance of z decreases and the value of z gets very close to the mean of zero, i.e., z would tend faster to zero as the number of used DCSs increases. Using more DCSs requires using more time slots; however, since more than one independent transmitter may be comprised in the wireless communication system 100 and those may transmit at the same time, this could compensate for the additionally required time slots.

If the direct propagation channel h₀ is weak, as it is customarily considered in DCSs and as can be assessed after the channel estimation, the receiver 104 may not take into account the terms proportional to h₀ and the combining matrix Q can be computed as in Equation (63):

$$Q = [ \begin{matrix}{h}_{1}^{*} & {h}_{2} & - {h}_{3} & 0 \\ {h}_{2}^{*} & - {h}_{1} & 0 & - {h}_{3} \\ {h}_{3}^{*} & 0 & {h}_{1} & {h}_{2}\end{matrix} ] \qquad ( 63 )$$

and the normalization matrix takes the form of Equation (64):

$$N = diag ( \frac{1}{{β}_{1} ( {\vert {h}_{1} \vert}^{2} + {\vert {h}_{2} \vert}^{2} + {\vert {h}_{3} \vert}^{2} )} , \\ \frac{1}{{β}_{2} ( {\vert {h}_{1} \vert}^{2} + {\vert {h}_{2} \vert}^{2} + {\vert {h}_{3} \vert}^{2} )} , \frac{1}{{β}_{3} ( {\vert {h}_{1} \vert}^{2} + {\vert {h}_{2} \vert}^{2} + {\vert {h}_{3} \vert}^{2} )} ) . \qquad ( 64 )$$

The value of β₁, β₂ and β₃ in the STDC matrix B, may be determined depending on the capabilities or properties of the DCSs 106-1, 106-2, 106-3. For example, for DCSs that only provide control of scattering phase shifts, the values of β₁, β₂ and β₃ may be of unit magnitude. Given specific values of β₁, β₂ and β₃, further simplifications or alternative implementations of the channel estimation and the estimation of the information symbol x at the at least one receiver 104 can be implemented.

Alternatively, the four initial estimates \hat{x}_{init,1}, \hat{x}_{init,2}, \hat{x}_{init,3}, \hat{x}_{init,4} of the transmitted symbol x can be obtained by applying the pseudoinverse of H in Equation (57) to the received signal vector.

Optionally, AWGN may be added to the received signal vector in Equation (58) to estimate the information symbol x. Thereby, the processing for combining with Q, normalizing with N and combining the initial estimates to obtain the final estimate of x as disclosed above, also take into account additional noise terms having lower magnitude than x.

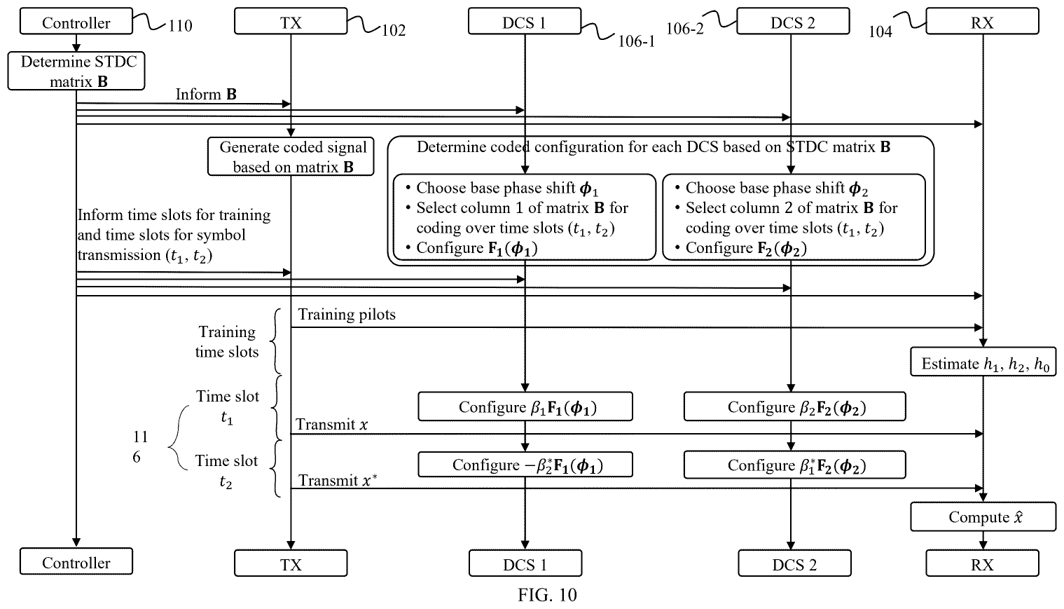

FIG. 10 shows an example of exchanged signaling in the wireless communication system 100 of FIG. 6. In particular, the example of FIG. 10 depicts a scenario where the radio wireless communication system 100 may comprise the controller 110, one transmitter 102, one receiver 104 and two DCSs 106-1, 106-2. Each DCS 106-1, 106-2 may comprise a scattering surface 107-1, 107-2, and each scattering surface 107-1, 107-2 may comprise a set of scattering elements 108-1, 108-2. The transmitter 102 and the DCSs 106-1, 106-2 may be synchronized.

The controller 110 may be configured to determine the STDC 112, that is, the controller 110 may be configured to determine the STDC matrix B, for example by following the flowchart disclosed above and shown in FIG. 5.

In this example, D=2 and it may be considered that Tₘₐₓ=2 and δ=2, as disclosed above for the example of FIG. 6.

Further, the controller 110 may be configured to send the total number T=2 of the plurality of time slots 116 and the STDC matrix B by signaling to the transmitter 102, to the receiver 104 and to the DCSs 106-1, 106-2. Additionally, the controller 110 may determine training time slots for channel estimation, and may send the training time slots by signaling to the transmitter 102, to the receiver 104 and to the DCSs 106-1, 106-2.

The controller 110 may be configured to determine the STDC matrix B offline, and may send the STDC matrix B, by signaling, to the transmitter 102, to the receiver 104 and to the DCSs 106-1, 106-2 before the transmitter 102 transmits the coded radiofrequency signal to the receiver 104 during the plurality of time slots 116.

The controller 110 may be further configured to control the transmitter 102, based on the STDC 112, to generate a coded radiofrequency signal during the T=2 time slots 116. That is, for each time slot 116 tᵢ, the transmitter 102 may be configured to transmit an information symbol x in the coded radiofrequency signal. The coded radiofrequency signal may comprise a transformation of the information symbol x based on the STDC matrix B, denoted as f_{TX} (x, B, tᵢ). Details regarding the coded information symbols by the transmitter 102 are as disclosed above for the example of FIG. 6 and are not repeated here again.

Further, the controller 110 may control, based on the STDC 112, the set of scattering elements 108-1, 108-2 of the DCS 106-1, 106-2 during the T=2 time slots 116. That is, for each time slot 116 tᵢ∈{t₁, t₂} of the T=2 time slots, the controller 110 may determine the coded configuration of each DCS 106-1, 106-2 by setting a scattering pattern equal to B_{i,d} F_{d} (ϕ_{d})=α_{d} F_{d} (ϕ_{d}), with α_{d}=B_{i,d} and with d=1, 2, where B_{i,d} is the entry in the i-th row and d-th column of the STDC matrix B as disclosed above, and F_{d} (ϕ_{d}) is the scattering pattern of each DCS d 106-1, 106-2.

Alternatively, the controller 110 may control each DCS 106-1, 106-2 to choose the respective d-th column of the STDC matrix B and to further determine its coded configuration mentioned above. Additionally or alternatively, the controller 110 may control each DCS 106-1, 106-2 during the plurality of time slots 116 in order to apply the determined coded configuration.

The coded configuration for each DCS 106-1, 106-2 is the same as for the example of FIG. 6. Details are not repeated again.

Further, the transmitter 102 may be configured, based on the STDC 112, to transmit training pilots p during the training time slots to the receiver 104, and the receiver may be configured to estimate the one or more propagation channels.

Then, the transmitter 102 may be configured to send the symbol x at the time slot t₁ and the symbol x* at the time slot t₂.

Then, the controller 110 may control the receiver 104 to obtain by reception, during the plurality of time slots 116, the coded radiofrequency signal transmitted by the transmitter 102. Then, the receiver 104 may be configured to determine the information symbol x transmitted by the at least one transmitter 102 based on the STDC 112, based on the received coded radiofrequency signal, and based on the estimated one or more propagation channels via the DCS 106-1, 106-2 additionally or alternatively the estimated one or more direct propagation channels.

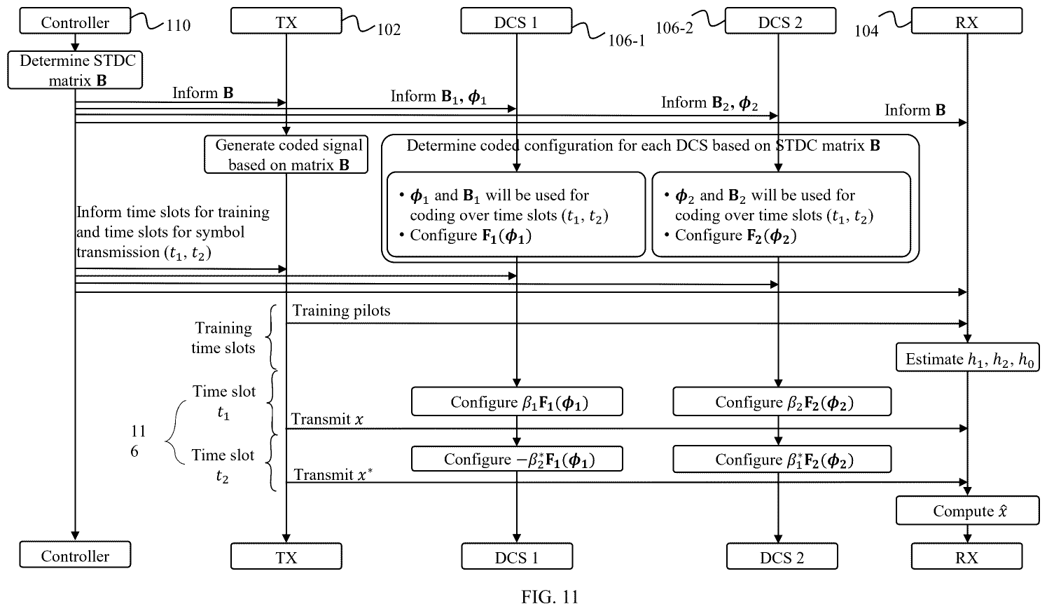

FIG. 11 shows another example of exchanged signaling in the wireless

communication system 100 of FIG. 6. The example of FIG. 11 is the same as the example of FIG. 10, except that in FIG. 11 the controller 110 may be further configured to determine the base phase shift configuration matrices ϕ₁, ϕ₂ for each DCS 106-1, 106-2. Then, the controller 110 may be configured to send the base phase shift configuration matrices ϕ₁, ϕ₂ by signaling to each DCSs 106-1, 106-2. Additionally, the controller 110 may be configured to send by signaling to each DCSs 106-1, 106-2 the respective d-th column of the STDC matrix B, instead of the full matrix STDC matrix B.

The remaining exchanged signaling between the controller 110, the transmitter 102, the receiver 104 and the DCS 106-1, 106-2, as well as their configuration, are the same as in the example of FIG. 10, and are not repeated here.

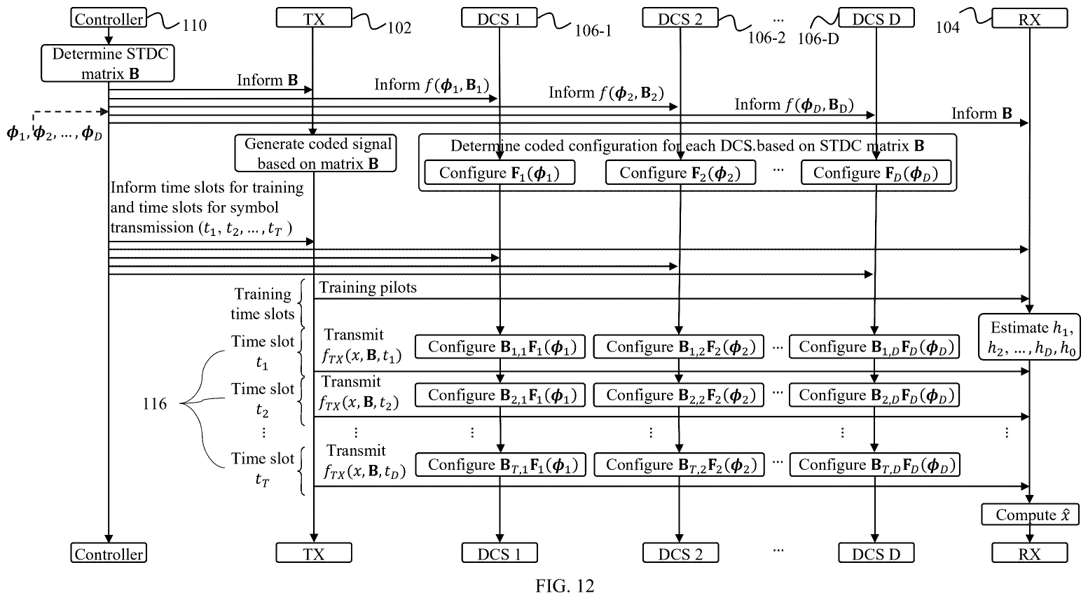

FIG. 12 shows an example of exchanged signaling in the wireless communication system 100. The example of FIG. 12 depicts a scenario where the radio wireless communication system 100 may comprise the controller 110, one transmitter 102, one receiver 104 and D DCSs, exemplary DCSs 106-1, 106-2 and 106-D. Each DCS 106-1, 106-2, 106-D may comprise a scattering surface 107-1, 107-2, 107-D, and each scattering surface 107-1, 107-2, 107-D may comprise a set of scattering elements 108-1, 108-2, 108-D. The transmitter 102 and the DCSs 104-1, 104-2, 104-D may be synchronized.

The controller 110 may be configured to determine the STDC 112, that is, the controller 110 may be configured to determine the STDC matrix B, for example by following the flowchart disclosed above and shown in FIG. 5.

The controller 110 may be configured to determine the STDC matrix B offline, and may send the STDC matrix B, by signaling, to the transmitter 102 and to the receiver 104 before the transmitter 102 transmits the coded radiofrequency signal to the receiver 104 during the plurality of time slots 116.

Further, the controller 110 may be configured to determine the base phase shift configuration matrices ϕ₁, ϕ₂, . . . , ϕ_{D} for each DCS 106-1, 106-2, 106-D. Then, the controller 110 may be configured to send by signaling to each DCSs 106-1, 106-2, 106-D a respective piece of information denoted as f (ϕ_{d}, B_{d}).

The piece of information f (ϕ_{d}, B_{d}) may comprise information for configuring the respective DCS d in several states and times specifying the base phase shift configuration matrix ϕ_{d} for each time slot 116 t₁, t₂, . . . , t_{T}. For example, the piece of information f (ϕ_{d}, B_{d}) may comprise the base phase shift configuration matrix ϕ_{d} and the respective code for each DCS 106-1, 106-2, 106-D, i.e., the respective d-th column of the STDC matrix B, denoted as B_{d}. Additionally or alternatively, the piece of information f (ϕ_{d}, B_{d}) may comprise any other type of information that may facilitate to achieve the desired configuration for each DCS 106-1, 106-2, 106-D.

The controller 110 may be configured to determine the information f (ϕ_{d}, B_{d}) offline and may subsequently send it by signaling to the respective DCSs 106-1, 106-2, 106-D.

Alternatively, the controller 110 may send each piece of information f (ϕ_{d}, B_{d}) at once or may send it at each time slot 116 t₁, t₂, . . . , t_{T}, i.e., the controller 110 may be configured to send by signaling each piece of information f (ϕ_{d}, B_{d}) to each DCSs 106-1, 106-2, 106-D when the configuration of each DCS is required 106-1, 106-2, 106-D to be updated.

Further, the controller 110 may be configured to send the total number T of the plurality of time slots 116 and the STDC matrix B by signaling to the transmitter 102 and to the receiver 104. Additionally, the controller 110 may determine training time slots for channel estimation, and may send the training time slots by signaling to the transmitter 102, to the receiver 104 and to the DCSs 106-1, 106-2, 106-D.

Then, the controller 110 may be configured to control, based on the STDC 112, the set of scattering elements 108-1, 108-2, 108-D of the DCS 106-1, 106-2, 106-D during the plurality of time slots 116. That is, for each time slot 116 tᵢ∈{t₁, t₂, . . . , t_{T}}, the controller 110 may determine the coded configuration of each 106-1, 106-2, 106-D by setting a scattering pattern equal to B_{i,d} F_{d} (ϕ_{d}), with d=1, 2, . . . , D and where B_{i,d} is the entry in the i-th row and d-th column of the STDC matrix B and F_{d} (ϕ_{d}) is the scattering pattern of each DCS 106-1, 106-2, 106-D.

For example, at the time slot t₁, the coded configuration for the DCS d=1 106-1 is equal to B_{1,1} F₁ (ϕ₁), the coded configuration for the DCS d=2 106-2 is equal to B_{1,2} F₂ (ϕ₂), and similar for each DCS d, as shown in FIG. 12. At the time slot t₂, the coded configuration for the DCS d=1 106-1 is equal to B_{2,1} F₁ (ϕ₁), the coded configuration for the DCS d=2 106-2 is equal to B_{2,2} F₂ (ϕ₂), and similarly the coded configuration for the DSC D 106-D at the time slot t_{T}, s equal to B_{T,D} F₁ (ϕ_{D}).

Alternatively, the controller 110 may control each DCS 106-1, 106-2, 106-D to determine its coded configuration.

Then, the controller 110 may control, based on the STDC 112, the transmitter 102 to generate the coded radiofrequency signal. Further, for each time slot 116 tᵢ∈{t₁, t₂, . . . , t_{T}}, the transmitter 102 may be configured to transmit an information symbol x in the coded radiofrequency signal. The coded radiofrequency signal may comprise the transformation of the information symbol x, denoted as f_{TX} (x, B, tᵢ), based on the STDC matrix B.

The transformation f_{TX} (x, B, tᵢ) may comprise the information symbol x at the time slot 116 tᵢ if entries of a respective i-th row of the STDC matrix B belong to {±β₁, ±β₂, . . . , ±β_{δ}, 0}, or an information symbol x* at the time slot 116 tᵢ if entries of the respective i-th row of the STDC matrix B belong to {±β*₁, ±β*₂, . . . , ±β*_{δ}, 0}, where x* is the complex conjugate of the information symbol x.

Then, the transmitter 102 may be configured to transmit training pilots p during the training time slots 116 to the receiver 104, and the receiver 104 may be configured to estimate the one or more propagation channels.

The transmitter 102 may be further configured to transmit the transformation of the information symbol f_{TX} (x, B, tᵢ), at each time slot 116 tᵢ∈{t₁, t₂, . . . , t_{T}}.

Then, the controller 110 may control the receiver 104 to obtain by reception, during the plurality of time slots 116, the coded radiofrequency signal transmitted by the transmitter 102. Then, the receiver may be configured to determine the information symbol x transmitted by the at least one transmitter 102 based on the STDC 112, based on the received coded radiofrequency signal, and based on the estimated one or more propagation channels via the DCS 106-1, 106-2, 106-D and/or the estimated one or more direct propagation channels.

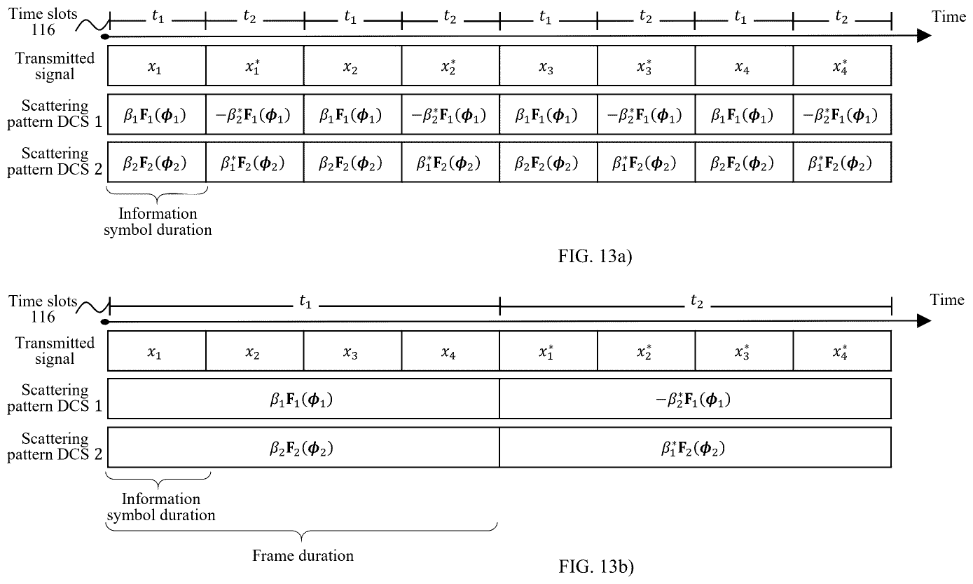

The STDC 112 according to this disclosure can be extended in a straightforward and flexible way to the case where multiple information symbols are transmitted per time slot. The duration of each time slot 116 tᵢ of the plurality of time slots {t₁, t₂, . . . , t_{T}} can be adapted to span the duration of one information symbol, as schematically shown in FIG. 13a), or the duration of multiple information symbols (sometimes also denoted as a frame) as schematically shown in FIG. 13a). FIG. 13a) shows an example of time slots 116 in the wireless communication system 100 of FIG. 6 for the case of four information symbols 116 transmitted, exemplary x₁, x₂, x₃, x₄, and where each time slot 116 spans the duration of one information symbol. FIG. 13b) shows an example of time slots 116 in the wireless communication system 100 of FIG. 6 for the case of four information symbols 116 transmitted, exemplary x₁, x₂, x₃, x₄, and where each time slot 116 spans the duration of multiple information symbols or a frame duration.

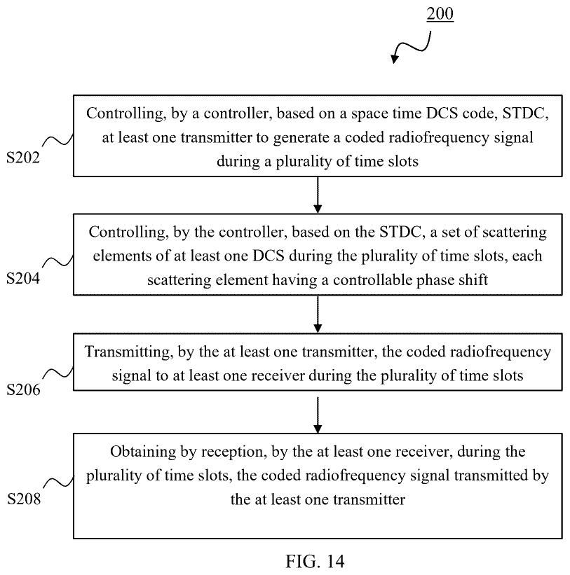

FIG. 14 shows a wireless communication method 200 according to this disclosure. The method 200 may be performed by the wireless communication system 100 of FIG. 4 as disclosed above.

The method 200 comprises a step S202 of controlling, by the controller 110, based on the space time DCS code 112, STDC, the at least one transmitter 102 to generate the coded radiofrequency signal during the plurality of time slots 116, where the STDC 112 depends on a total number of the at least one DCS 106 and a maximum number of the plurality of time slots 116 Tₘₐₓ.

The method 200 further comprises a step S204 of controlling, by the controller 110, based on the STDC 112, the set of scattering elements 108 of the at least one DCS 106 during the plurality of time slots 116. The at least one DCS 106 comprises a scattering surface 107 that comprises the set of scattering elements 108, each scattering element 108 having a controllable phase shift.

Further, the method 200 comprises a step S206 of transmitting, by the at least one transmitter 102, the coded radiofrequency signal to the at least one receiver 104 during the plurality of time slots 116.

The method 200 further comprises a step S208 of obtaining by reception, by the at least one receiver 104, during the plurality of time slots 116, the coded radiofrequency signal transmitted by the at least one transmitter 102.

The coded radiofrequency signal transmitted by the at least one transmitter 102 during the plurality of time slots 116 propagates from the at least one transmitter 102 to the at least one receiver 104 through one or more propagation channels 114, the one or more propagation channels 114 comprising one or more propagation channels via the at least one DCS 106, additionally or alternatively one or more direct propagation channels.

The method 200 may further comprise actions according to the described aforementioned exemplary embodiment of the wireless communication system 100. Hence, the method 200 achieves the same advantages as the wireless communication system 100 as disclosed above.

The present disclosure further provides a computer program product comprising a program code for carrying out, when implemented on a processor, the method 200 shown in FIG. 14. The computer program may be included in a computer readable medium of the computer program product. The computer readable medium may comprise essentially any memory, such as a ROM (Read-Only Memory), a PROM (Programmable Read-Only Memory), a EPROM (Erasable PROM), a Flash memory, an EEPROM (Electrically Erasable PROM), or a hard disk drive.

The computer program product may further comprise actions according to the described aforementioned method 200. Hence, the computer program product achieves the same advantages as the method 200 and as the wireless communication system 100.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A wireless communication system comprising:
at least one transmitter, configured to transmit a coded radiofrequency signal to at least one receiver during a plurality of time slots;
at least one digitally controllable scatterer, DCS, the DCS comprising a scattering surface that comprises a set of scattering elements, each scattering element having a controllable phase shift;
a controller, configured to:
control, based on a space time DCS code, STDC, the at least one transmitter to generate the coded radiofrequency signal during the plurality of time slots;
control, based on the STDC, the set of scattering elements of the at least one DCS during the plurality of time slots; and
at least one receiver, configured to obtain by reception, during the plurality of time slots, the coded radiofrequency signal transmitted by the at least one transmitter;
wherein the coded radiofrequency signal transmitted by the at least one transmitter during the plurality of time slots propagates from the at least one transmitter to the at least one receiver through one or more propagation channels, the one or more propagation channels comprising one or more propagation channels via the at least one DCS and/or one or more direct propagation channels; and
wherein the STDC depends on a total number of the at least one DCS and a maximum number of the plurality of time slots Tₘₐₓ.

2. The wireless communication system according to claim 1, wherein the STDC comprises a STDC matrix B, the STDC matrix B having a dimension T×D, wherein D is a total number of the at least one DCS, with D≥1, and T≤Tₘₐₓ is a total number of the plurality of time slots.

3. The wireless communication system according to claim 1, wherein the STDC matrix B is defined based on δ≤D complex values {β₁, β₂, . . . , β_{δ}}, wherein entries of a row i of the matrix B belong either to {±β₁, ±β₂, . . . , ±β_{δ}, 0} or to {±β*₁, ±β*₂, . . . , ±β*_{δ}, 0}, wherein [symbol] is the complex conjugate of [symbol] for ∀ [symbol] ∈{1, . . . , D} and Tₘₐₓ satisfies Tₘₐₓ≥D.

4. The wireless communication system according to claim 1, wherein a code for each of the at least one DCS d, with d∈{1,2, . . . , D}, is determined by a respective d-th column of the STDC matrix B, the d-th column of the STDC matrix B being denoted as B_{d}.

5. The wireless communication system according to claim 1, wherein, for a time slot tᵢ∈{t₁, t₂, . . . , t_{T}}, the controller is configured to determine a coded configuration for each of the at least one DCS d, with d∈{1,2, . . . , D}, as B_{i,d} F_{d} (ϕ_{d}), wherein F_{d}(ϕ_{d}) is a scattering pattern of the at least one DCS d, ϕ_{d} is a base phase shift configuration matrix of the at least one DCS d, and B_{i,d} denotes an entry in an i-th row of the respective code B_{d}.

6. The wireless communication system according to claim 1, wherein, for each time slot tᵢ, with tᵢ∈{t₁, t₂, . . . , t_{T}}, the at least one transmitter is further configured to:
transmit an information symbol x in the coded radiofrequency signal;
wherein the coded radiofrequency signal comprises a transformation of the information symbol x based on the STDC matrix B, the transformation of the information symbol x comprising:
the information symbol x at the time slot tᵢ if entries of a respective i-th row of the STDC matrix B belong to {±β₁, ±β₂, . . . , ±β_{δ}, 0}; or
an information symbol x* at the time slot tᵢ if entries of the respective i-th row of the STDC matrix B belong to {±β*₁, ±β*₂, . . . , ±β*_{δ}, 0}, wherein x+is the complex conjugate of the information symbol x.

7. The wireless communication system according to claim 1, wherein the at least one receiver is configured to:
estimate the one or more propagation channels via the at least one DCS and/or the one or more direct propagation channels.

8. The wireless communication system according to claim 1, wherein for each time slot tᵢ, with tᵢ∈{t₁, t₂, . . . , t_{T}}, the at least one receiver is further configured to:
determine the information symbol x transmitted by the at least one transmitter based on the STDC, based on the received coded radiofrequency signal, and based on the estimated one or more propagation channels via the at least one DCS and/or the estimated one or more direct propagation channels.

9. The wireless communication system according to claim 2, wherein one of the controller, the at least one transmitter, the at least one receiver or the at least one DCS is further configured to:
determine the STDC matrix B; and
send the total number T of the plurality of time slots and the STDC matrix B by signaling to the controller and/or the at least one transmitter and/or the at least one receiver and/or the at least one DCS; and/or send by signaling to the at least one DCS d the respective d-th column of the STDC matrix B and the total number T of the plurality of time slots.

10. The wireless communication system according to claim 9, wherein the STDC matrix B is determined offline, and the STDC matrix B and/or the d-th column of the STDC matrix B, is sent by signaling before the at least one transmitter transmits the coded radiofrequency signal.

11. The wireless communication system according to claim 1, wherein the at least one transmitter and the at least one DCS are synchronized.

12. A wireless communication method comprising:
controlling, by a controller, based on a space time DCS code, STDC, at least one transmitter to generate a coded radiofrequency signal during a plurality of time slots;
controlling, by the controller, based on the STDC, a set of scattering elements of at least one DCS during the plurality of time slots, the at least one DCS comprising a scattering surface that comprises the set of scattering elements, each scattering element having a controllable phase shift;
transmitting, by the at least one transmitter, the coded radiofrequency signal to at least one receiver during the plurality of time slots; and
obtaining by reception, by the at least one receiver during the plurality of time slots, the coded radiofrequency signal transmitted by the at least one transmitter;
wherein the coded radiofrequency signal transmitted by the at least one transmitter during the plurality of time slots propagates from the at least one transmitter to the at least one receiver through one or more propagation channels, the one or more propagation channels comprising one or more propagation channels via the at least one DCS and/or one or more direct propagation channels; and
wherein the STDC depends on a total number of the at least one DCS and a maximum number of the plurality of time slots Tₘₐₓ.

13. The wireless communication method according to claim 12, wherein the STDC comprises a STDC matrix B, the STDC matrix B having a dimension T×D, wherein D is a total number of the at least one DCS, with D≥1, and T≤Tₘₐₓ is a total number of the plurality of time slots.

14. The wireless communication method according to claim 12, wherein the STDC matrix B is defined based on δ≤D complex values {β₁, β₂, . . . , δ_{δ}}, wherein entries of a row i of the matrix B belong either to {±β₁, ±β₂, . . . , ±β_{δ}, 0} or to {±β*₁, ±β*₂, . . . , ±β*_{δ}, 0}, wherein [symbol] is the complex conjugate of [symbol] for ∀ [symbol] ∈{1, . . . , D} and Tₘₐₓ satisfies Tₘₐₓ≥D.

15. The wireless communication method according to claim 12, wherein a code for each of the at least one DCS d, with d∈{1,2, . . . , D}, is determined by a respective d-th column of the STDC matrix B, the d-th column of the STDC matrix B being denoted as B_{d}.

16. The wireless communication method according to claim 12, wherein, for a time slot tᵢ∈{t₁, t₂, . . . , t_{T}}, the controller is configured to determine a coded configuration for each of the at least one DCS d, with d∈{1,2, . . . , D}, as B_{i,d}F_{d}(ϕ_{d}), wherein F_{d}(ϕ_{d}) is a scattering pattern of the at least one DCS d, ϕ_{d} is a base phase shift configuration matrix of the at least one DCS d, and B_{i,d} denotes an entry in an i-th row of the respective code B_{d}.

17. The wireless communication method according to claim 12, further comprises:
for each time slot tᵢ, with tᵢ∈{t₁, t₂, . . . , t_{T}}, transmit, by the at least one transmitter, an information symbol x in the coded radiofrequency signal;
wherein the coded radiofrequency signal comprises a transformation of the information symbol x based on the STDC matrix B, the transformation of the information symbol x comprising:
the information symbol x at the time slot tᵢ if entries of a respective i-th row of the STDC matrix B belong to {±β₁, ±β₂, . . . , ±β_{δ}, 0}; or
an information symbol x* at the time slot tᵢ if entries of the respective i-th row of the STDC matrix B belong to {±β*₁, ±β*₂, . . . , ±β*_{δ}, 0}, wherein x* is the complex conjugate of the information symbol x.

18. The wireless communication method according to claim 12, further comprises:
estimate, by the at least one receiver, the one or more propagation channels via the at least one DCS and/or the one or more direct propagation channels.

19. The wireless communication method according to claim 12, further comprises:
for each time slot tᵢ, with tᵢ∈{t₁, t₂, . . . , t_{T}}, determine, by the at least one receiver, the information symbol x transmitted by the at least one transmitter based on the STDC, based on the received coded radiofrequency signal, and based on the estimated one or more propagation channels via the at least one DCS and/or the estimated one or more direct propagation channels.

20. A non-transitory computer-readable storage medium comprising instructions which, when executed by a hardware of a wireless communication system, cause the wireless communication system to:
controlling, by a controller, based on a space time DCS code, STDC, at least one transmitter to generate a coded radiofrequency signal during a plurality of time slots;
controlling, by the controller, based on the STDC, a set of scattering elements of at least one DCS during the plurality of time slots, the at least one DCS comprising a scattering surface that comprises the set of scattering elements, each scattering element having a controllable phase shift;
transmitting, by the at least one transmitter, the coded radiofrequency signal to at least one receiver during the plurality of time slots; and
obtaining by reception, by the at least one receiver during the plurality of time slots, the coded radiofrequency signal transmitted by the at least one transmitter;
wherein the coded radiofrequency signal transmitted by the at least one transmitter during the plurality of time slots propagates from the at least one transmitter to the at least one receiver through one or more propagation channels, the one or more propagation channels comprising one or more propagation channels via the at least one DCS and/or one or more direct propagation channels; and
wherein the STDC depends on a total number of the at least one DCS and a maximum number of the plurality of time slots Tₘₐₓ.
